(19) United States
(12) Patent Application Publication
(10) Pub. No.: US 2024/0182760 A1
(43) Pub. Date: Jun. 6, 2024

(54) A COMPOSITION

(71) Applicant: DataLase Ltd., Widnes Cheshire (GB)

(72) Inventor: Martin Walker, Widnes Cheshire (GB)

(21) Appl. No.: 18/549,799

(22) PCT Filed: Mar. 10, 2022
(86) PCT No.: PCT/EP2022/056202

§ 371 Date: Sep. 8, 2023

(30) Foreign Application Priority Data
Mar. 10, 2021 (EP) 21161875.6

(51) Int. Cl. C09J 11/04; C08K 3/22; C08K 3/32; C08K 5/00; C09J 11/06; C09J 123/08

(52) U.S. Cl. CPC C09J 11/04; C08K 3/22; C08K 3/32; C08K 5/0041; C09J 11/06; C09J 123/0853; C08K 2003/2255; C08K 2003/321

(57) ABSTRACT

The present invention relates to a composition formed of a hot melt adhesive having a colour-forming compound admixed therein. The invention further relates to a substrate or multi-layer substrate construction having the composition applied thereon or therein, and methods of forming colour and/or an image on and/or within the substrate or multi-layer substrate construction using said composition.

### FIELD OF THE INVENTION

The present invention relates to a composition for use in the formation of colour and/or an image on and/or within a substrate or multi-layer substrate construction.

The present invention further relates to a substrate or multi-layer substrate construction having the composition applied thereon and/or incorporated therein, and a method of forming colour or an image on and/or within such a substrate or multi-layer substrate construction.

### BACKGROUND OF THE INVENTION

The use of laser-reactive compositions comprising colour-forming compounds to produce human and/or machine-readable images and variable information is known. Following application of such a laser-reactive composition to a substrate, an image(s) can be formed upon application of an appropriate stimulus to the laser-reactive composition. The stimulus, such as radiation, affects the colour-forming compound causing it to display colour, or a colour change, in the areas of the composition to which the stimulus has been applied, such that an image is formed.

In an unrelated technology field, hot melt adhesives are used to provide effective bonding of surfaces of the same or different substrates. Hot melt adhesives typically exist at ambient temperature in a solid form, for example, as sticks, blocks, beads, pellets, balls, rods, granules or powder. These hot melt adhesives are thermoplastic materials, commonly utilised in devices such as hot glue guns and hot glue applicators. When in use, the heating element of the device heats the hot melt adhesive above ambient temperature causing it to become molten, i.e. liquefied by heat, such that it can be transferred from the device and applied, as required, to the surfaces of the substrate(s) to be bonded. These substrate surfaces are then brought into contact while the hot melt adhesive is still sufficiently molten and tacky, and as the hot melt adhesive cools to ambient temperature, it successfully bonds the substrate surfaces together. Hot melt adhesives are thus well known as materials suitable for the adhering and bonding of substrate surfaces.

### SUMMARY OF THE INVENTION

According to a first aspect of the present invention, there is provided a composition formed of a hot melt adhesive having a colour-forming compound admixed therein, wherein the colour-forming compound is selected from a leuco dye and an oxyanion of a multivalent metal or an oxyacid or hydrate thereof, and when the colour-forming compound is a leuco dye:
(a) the leuco dye is selected from 2′-Anilino-6′-(dibutylamino)-3′-methyl-3H-spiro[2-benzofuran-1,9′-xanthen]-3-one, and 2-Anilino-6′-[ethyl(p-toyl)amino]-3′-methylspiro[5 isobenzofuran-1(3H), 9′-[9H]xanthene]-3-one;
(b) the hot melt adhesive further has a thermal acid-generating agent admixed therein, the thermal acid-generating agent being selected from 1,1,1-Tris(4-Hydroxyphenyl) Ethane (THPE), tri-n-butylammonium-4,4′-dioxo-4H,4′H-2,2′-spirobi[benzo[d][1,3,2]dioxaborinin]-2-uide, N, N-dibutylbutan-1-aminium bis[2-(hydroxy-kO)benzoato(2-)-kO]borate(1-), 4-hydroxy-4′-isopropoxydiphenylsulfone, (2,4-dihydroxyphenyl)phenylmethanone, 3-(3-tosylureido)phenyl-4-methylbenzenesulfonate, propyl-3,4,5-trihydroxybenzoate and 4,4′-methanediyldiphenol, and
(c) the melting temperature of the hot melt adhesive is lower than the melting temperature of both the leuco dye and thermal acid-generating agent; and when the colour-forming compound is an oxyanion of multivalent metal or an oxyacid or hydrate thereof, the melting temperature of the hot melt adhesive is lower than the decomposition temperature of the oxyanion of a multivalent metal or an oxyacid or hydrate thereof.

According to a second aspect of the present invention, there is provided a composition formed of a hot melt adhesive having a colour-forming compound and an infrared radiation absorbing compound admixed therein, wherein the colour-forming compound is selected from a leuco dye or an oxyanion of a multivalent metal or an oxyacid or hydrate thereof, and wherein:
when the colour-forming compound is a leuco dye, the hot melt adhesive further has a thermal acid-generating agent admixed therein and the melting temperature of the hot melt adhesive is lower than the melting temperature of both of the leuco dye and thermal acid-generating agent; and
when the colour-forming compound is an oxyanion of a multivalent metal or an oxyacid or hydrate thereof, the melting temperature of the hot melt adhesive is lower than the decomposition temperature of the oxyanion of a multivalent metal or an oxyacid or hydrate thereof.

According to a third aspect of the present invention, there is provided a composition formed of a hot melt adhesive having a colour-forming compound admixed therein, wherein the colour-forming compound is selected from ammonium octamolybdate, and the following leuco dyes: 2′-Anilino-6′-(dibutylamino)-3′-methyl-3H-spiro[2-benzofuran-1,9′-xanthen]-3-one, and 2-Anilino-6′-[ethyl(p-toyl)amino]-3′-methylspiro[5isobenzofuran-1(3H), 9′-[9H]xanthene]-3-one, and wherein when the colour-forming compound is a leuco dye, the hot melt adhesive further has a thermal acid-generating agent, 1,1,1-Tris(4-Hydroxyphenyl) Ethane, admixed therein.

According to a fourth aspect of the present invention, there is provided a substrate comprising a composition according to the first, second or third aspect of the present invention applied thereon.

According to a fifth aspect of the present invention, there is provided a multi-layer substrate construction comprising a composition according to the first, second or third aspect of the present invention applied thereon and/or incorporated therein.

According to a sixth aspect of the present invention, there is provided a method of forming a composition according to the first, second or third aspect of the present invention, the method comprising: heating the hot melt adhesive to a temperature at or above the melting temperature of the hot melt adhesive, but below the melting temperature or decomposition temperature of the colour-forming compound, and when present, the melting temperature of the thermal acid-generating agent or infrared radiation absorbing compound, such that the hot melt adhesive becomes molten, and admixing the colour-forming compound and optionally, the thermal acid-generating agent and infrared radiation absorbing compound, in the molten hot melt adhesive such that it is distributed throughout the molten hot melt adhesive.

According to a seventh aspect of the present invention, there is provided a method of forming a substrate comprising a composition according to the first, second or third aspect of the present invention applied thereon, wherein the method comprises: heating of the composition to a temperature at or above the melting temperature of the hot melt adhesive, but below the melting temperature or decomposition temperature of the colour-forming compound, and when present, the melting temperature of the thermal acid-generating agent or infrared radiation absorbing compound such that the hot melt adhesive becomes molten; applying the composition to the substrate when the hot melt adhesive is molten; and allowing the composition to cool and solidify on the substrate.

According to an eighth aspect of the present invention, there is provided a method of forming a multi-layer substrate construction comprising a composition according to the first, second or third aspect of the present invention applied thereon, wherein the method comprises: heating of the composition to a temperature at or above the melting temperature of the hot melt adhesive, but below the melting temperature or decomposition temperature of the colour-forming compound, and when present, the melting temperature of the thermal acid-generating agent or infrared radiation absorbing compound such that the hot melt adhesive becomes molten; applying the composition to the substrate when the hot melt adhesive is molten; and allowing the composition to cool and solidify.

According to a ninth aspect of the present invention, there is provided a method of forming a multi-layer substrate construction having a composition according to the first, second or third aspect of the present invention incorporated therein, wherein the method comprises: heating of the composition to a temperature at or above the melting temperature of the hot melt adhesive, but below the melting temperature or decomposition temperature of the colour-forming compound, and when present, the melting temperature of the thermal acid-generating agent or infrared radiation absorbing compound such that the hot melt adhesive becomes molten; applying the composition to the substrate when the hot melt adhesive is molten; and bringing the substrate into contact with another substrate with the composition positioned therebetween such that the substrate are bonded together by the composition to form a multi-layer substrate construction.

According to a tenth aspect of the present invention, there is provided a method of forming colour and/or an image on a substrate comprising a composition according to the first, second or third aspect of the present invention applied thereon, wherein the method comprises applying radiation to the composition as required to form colour and/or an image on the substrate.

According to an eleventh aspect of the present invention, there is provided a method of forming colour and/or an image on and/or within a multi-layer substrate construction comprising a composition according to the first, second or third aspect of the present invention applied thereon and/or incorporated therein wherein the method comprises applying radiation to the composition as required to form colour and/or an image on and/or within the multi-layer substrate construction.

According to a twelfth aspect of the present invention, there is provided a use of a composition according to the first, second or third aspect of the present invention in the formation of colour and/or an image.

According to a thirteenth aspect of the present invention, there is provided a use of a composition according to the first, second or third aspect of the present invention in the formation of colour and/or an image on a substrate having said composition applied thereon.

According to a fourteenth aspect of the present invention, there is provided a use of a composition according to the first, second or third aspect of the present invention in the formation of colour and/or an image on and/or within a multi-layer substrate construction having said composition applied thereon and/or incorporated therein.

### DETAILED DESCRIPTION OF THE DRAWINGS

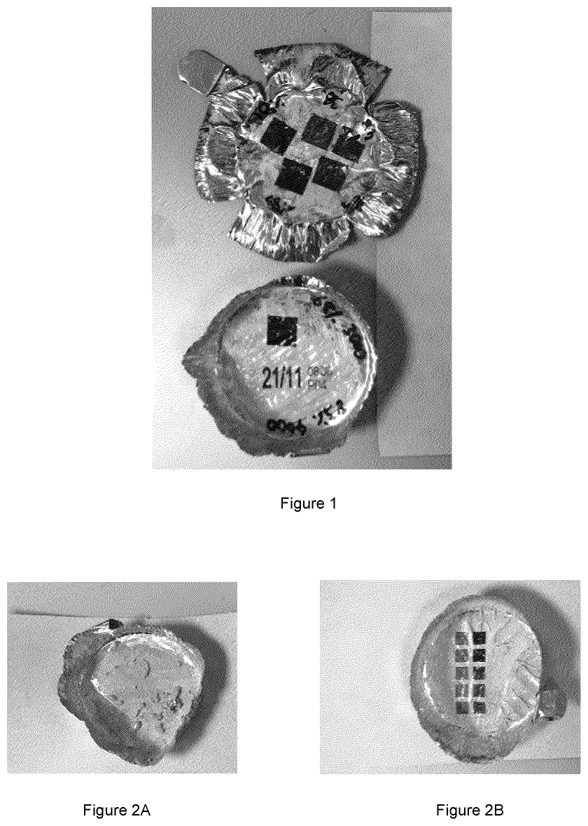

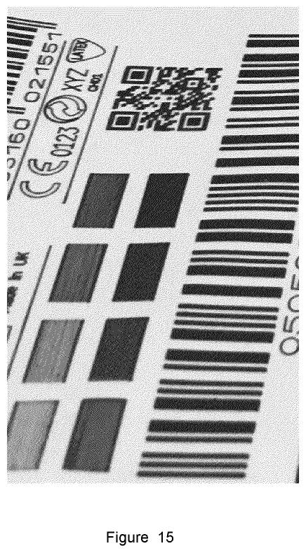

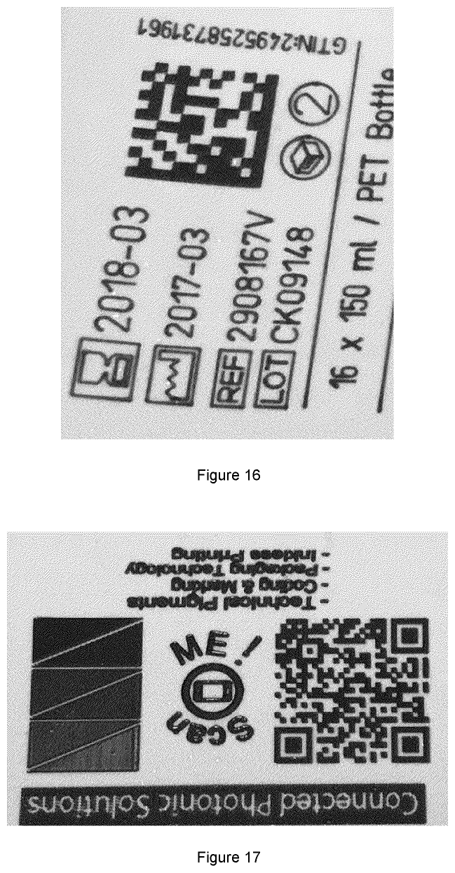

FIGS. 1 to 20 demonstrate the formation of colour and images on compositions according to the first, second and third aspects of the present invention and on substrates according to the fourth aspect of the present invention.

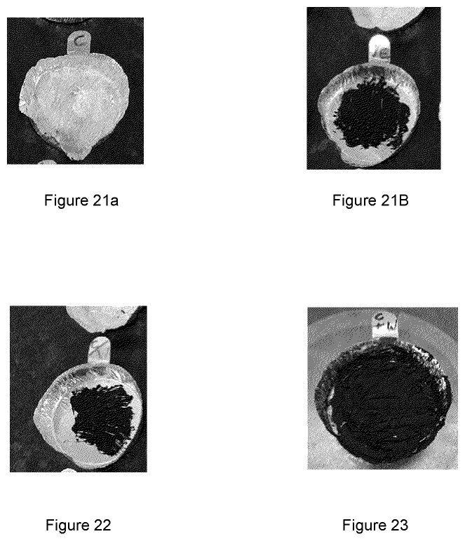

FIGS. 21a, 21b, 22 and 23 show comparative compositions, not according to the present invention. Colour and/or images cannot be formed upon subsequent application of radiation when using such compositions.

### DETAILED DESCRIPTION OF THE INVENTION

It has been surprisingly and advantageously found that hot melt adhesives can be advantageously utilised for other purposes, in addition to adhesion and the bonding of substrate surfaces. The present inventors have identified that hot melt adhesives can be advantageously utilised to transfer a colour-forming compound to a substrate or multi-layer substrate construction to render the substrate or multi-layer substrate construction capable of displaying colour and/or an image. The present invention has particular application in the packaging and printing industries, specifically for the formation of variable information images on the exterior of packaging. The present invention demonstrates numerous benefits and advantages in comparison to known printing and packaging technologies, as will be discussed in more detail below.

It has been surprisingly and advantageously found that colour-forming compounds can be incorporated into a hot melt adhesive to form a composition that can be applied to a substrate or multi-layer substrate construction, or used in the formation of a multi-layer substrate construction, and subsequently exposed to radiation, preferably from a laser source(s), such that colour and/or an image can be formed on and/or within the substrate or multi-layer substrate construction. No coloration which would mean that the formation of colour and/or an image by the subsequent application of radiation cannot take place occurs during the manufacture of the composition, or application of the composition to a substrate and/or multi-layer substrate construction prior to the specific application of radiation. The composition can advantageously be applied to either an exterior surface of a substrate or multi-layer substrate construction to facilitate the formation of colour and/or an image thereon, and/or used to bond two substrates of a multi-layer substrate construction together and facilitate the formation of colour and/or an image therein.

In the formation of compositions according to the present invention, the hot melt adhesive requires heating from ambient temperature such that it becomes molten in order for effective mixing, manufacture and incorporation of the colour-forming compound to take place therewithin. Furthermore, the hot melt adhesive of the compositions according to the present invention require heating so as to be molten and enable the composition to be applied to substrate(s) or multi-layer substrate construction(s), and/or used in the formation of multi-layer substrate construction(s). This requires heating of the composition to temperatures above ambient temperature.

For the compositions of the present invention, it is therefore certainly surprising that, during this heating of the composition above ambient temperature such that it becomes molten, i.e. during the manufacture, processing and application of the composition to a substrate(s) or multi-layer substrate construction, and/or its use in the formation of a multi-layer substrate construction, the colour-forming compound admixed within the hot melt adhesive is not affected by the temperature increase and desired colour and/or image formation on and/or within the substrate or multi-layer substrate construction can be initiated upon specific and controlled application of radiation, preferably using a laser source, following application of the composition to the substrate or multi-layer substrate construction, and/or after its use in the formation of the multi-layer substrate construction. Controlled production of human and/or machine readable images, in particular variable information human and/or machine readable images is therefore advantageously accomplished. It is particularly surprising as the colour-forming compounds are typically thermosensitive. In particular, colour-forming compounds such as leuco dyes typically have a low heat-sensitivity. It is therefore surprising to the present inventors that colour-forming compounds, including leuco dyes, can be utilised in the compositions of the present invention that require heating during manufacture, processing and application.

Further, it has been surprisingly and advantageously found that the nature of the compositions of the present invention means that they can be directly applied to a substrate(s) or multi-layer substrate construction(s), and/or used in the formation of a multi-layer substrate construction(s), without requiring dilution. Many printing processes for laser-reactive colour-forming compositions, such as those requiring low viscosity liquid formulations, involve dilution of the compositions prior to application to a substrate(s). This can negatively affect the active solids concentration of the colour-forming compound(s) and thus, the optical density of the colour and/or image formed on exposure to radiation. However, for the compositions of the present invention, high optical density colour and/or images can be achieved as the concentration of the colour-forming compounds in the compositions remains unchanged, undiluted and sufficiently high.

Still further, many printing processes for known laser-reactive colour-forming compositions utilise a printing press, which can lead to a significant amount of waste, i.e. unused composition. In addition, known processes used to apply laser-reactive colour-forming compositions are typically only capable of applying layers of composition to a substrate at a low coating weight. Unless a significant number of layers of the composition are applied, insufficient colour-forming compound is transferred to a substrate leading to poor, low quality colour and/or image formation with low optical density. The compositions of the present invention remove these issues, and provide an easier, and more reliable method, for the effective formation of colour and/or image on substrates.

Furthermore, it has been surprisingly and advantageously found that the compositions of the present invention can demonstrate improved colour and image stability over time, even when present on the exterior surface of a substrate or multi-layer substrate constructions and exposed to environmental conditions. The hot melt adhesive of the compositions is hydrophobic and insoluble in water, such that moisture is excluded therefrom. This enables the compositions of the present invention to demonstrate an increased environmental resistance to factors such as high humidity or wet conditions at ambient temperatures, maintaining high optical density colour and/or images over time. This is particularly advantageous when the compositions act as labels and are exposed on the exterior of substrates or multi-layer substrate constructions, such as packaging substrates.

It has been further surprisingly and advantageously found that application of the compositions of the present invention directly onto and/or within a substrate or multi-layer substrate construction enables integrated labels to be formed in packaging products. The label may be exposed on the exterior surface of the substrate or multi-layer substrate construction such that it is exposed, and/or incorporated within the multi-layer substrate construction. Not only does addition of the variable information to the product provide an attractive appearance to the packaging product, it is also desirable for tracking, tagging and tracing of products. The integrated label, and variable information it displays, cannot be intentionally or accidentally removed from the product (an outcome that would be detrimental to identification of the product as any information assigned to the product by the label would be lost). By integrating a label into the packaging, there is therefore an added security benefit.

Still further, it has been surprisingly and advantageously found that the compositions of the present invention demonstrate improved environmental and sustainability credentials. In such instances, the hot melt adhesive of the compositions of the present invention may be formed of a recyclable, biodegradable and/or compostable material. Application of compositions of the present invention comprising such recyclable, biodegradable and/or compostable materials directly onto or within similarly recyclable, biodegradable and/or compostable substrates and/or multi-layer substrate constructions enables substrates to be formed which can be recycled, biodegraded or composted as a whole. The compositions of the present invention therefore demonstrate particular environmental and sustainability advantages when the hot melt adhesive is formed of a biodegradable and/or compostable material such as a bio-plastic material, and the substrate or multi-layer substrate construction to which the composition is applied and/or incorporated within is also similarly biodegradable and/or compostable, for example, cardboard, paperboard or a bio-plastic material. In such instances, the entire product with an integrated variable information displaying label is biodegradable and/or compostable.

By the term “ambient temperature” as used herein is meant a temperature of from 10 to 35° C., typically 18 to 28° C. Ambient temperature is encompassed by the broader definition of “ambient conditions”, which refers to the normal range of conditions of the surrounding environment to which the composition is exposed, i.e. the range of temperatures, pressures and atmospheric conditions to which the composition is exposed during use, storage and otherwise. This includes solar radiation including electromagnetic radiation of X-rays, ultraviolet (UV) and infrared (IR) radiation. Typically, ambient conditions include a temperature of from 10 to 35° C., a pressure of from 20 to 100 kPa, and the environment is typically an oxygen-containing atmosphere.

According to a first aspect of the present invention, there is provided a composition formed of hot melt adhesive having a colour-forming compound admixed therein, wherein the colour-forming compound is selected from a leuco dye and an oxyanion of a multivalent metal or an oxyacid or hydrate thereof, and when the colour-forming compound is a leuco dye:
(a) the leuco dye is selected from 2′-Anilino-6′-(dibutylamino)-3′-methyl-3H-spiro[2-benzofuran-1,9′-xanthen]-3-one, and 2-Anilino-6′-[ethyl(p-toyl)amino]-3′-methylspiro[5isobenzofuran-1(3H), 9′-[9H]xanthene]-3-one;
(b) the hot melt adhesive further has a thermal acid-generating agent admixed therein, the thermal acid-generating agent being selected from 1,1,1-Tris(4-Hydroxyphenyl) Ethane (THPE), tri-n-butylammonium-4,4′-dioxo-4H,4′H-2,2′-spirobi[benzo[d][1,3,2]dioxaborinin]-2-uide, N, N-dibutylbutan-1-aminium bis[2-(hydroxy-kO)benzoato(2-)-kO]borate(1-), 4-hydroxy-4′-isopropoxydiphenylsulfone, (2,4-dihydroxyphenyl)phenylmethanone, 3-(3-tosylureido)phenyl-4-methylbenzenesulfonate, propyl-3,4,5-trihydroxybenzoate and 4,4′-methanediyldiphenol, and
(c) the melting temperature of the hot melt adhesive is lower than the melting temperature of both of the leuco dye and thermal acid-generating agent; and when the colour-forming compound is an oxyanion of multivalent metal or an oxyacid or hydrate thereof, the melting temperature of the hot melt adhesive is lower than the decomposition temperature of the oxyanion of a multivalent metal or an oxyacid or hydrate thereof.

According to a second aspect of the present invention, there is provided a composition formed of a hot melt adhesive having a colour-forming compound and an infrared radiation absorbing compound admixed therein, wherein the colour-forming compound is selected from a leuco dye or an oxyanion of a multivalent metal or an oxyacid or hydrate thereof, and wherein:
when the colour-forming compound is a leuco dye, the hot melt adhesive further has a thermal acid-generating agent admixed therein and the melting temperature of the hot melt adhesive is lower than the melting temperature of both of the leuco dye and thermal acid-generating agent; and
when the colour-forming compound is an oxyanion of a multivalent metal or an oxyacid or hydrate thereof, the melting temperature of the hot melt adhesive is lower than the decomposition temperature of the oxyanion of a multivalent metal or an oxyacid or hydrate thereof.

According to a third aspect of the present invention, there is provided a composition formed of a hot melt adhesive having a colour-forming compound admixed therein, wherein the colour-forming compound is selected from ammonium octamolybdate, and the following leuco dyes: 2′-Anilino-6′-(dibutylamino)-3′-methyl-3H-spiro[2-benzofuran-1,9′-xanthen]-3-one, and 2-Anilino-6′-[ethyl(p-toyl)amino]-3′-methylspiro[5isobenzofuran-1(3H), 9′-[9H]xanthene]-3-one, and wherein when the colour-forming compound is a leuco dye, the hot melt adhesive further has a thermal acid-generating agent, 1,1,1-Tris(4-Hydroxyphenyl)Ethane, admixed therein.

Hot melt adhesives are known in the art. A hot melt adhesive is a thermoplastic adhesive material that is solid at ambient temperature, but transitions from the solid state upon application of heat to become molten and able to flow. It returns to the solid state once cooled back to ambient temperature. By the term ‘molten’ in reference to the hot melt adhesive is meant that the hot melt adhesive is able to flow. It may be viscous, but will be able to flow. To become molten, the hot melt adhesive is heated to or above its melting temperature. The melting temperature of the hot melt adhesive is the temperature at which the hot melt adhesive becomes molten and able to flow. It is the temperature at which the hot melt adhesive transitions from a solid state into a viscous flow state. This may sometimes be known in the art as the softening temperature. It will be appreciated that this melting temperature is effectively the minimum processing temperature of the hot melt adhesive. It will be appreciated by a skilled person that in the context of the present invention, there is typically a melting temperature range over which the hot melt adhesive becomes molten and is therefore able to flow. This can occur, for example, when a hot melt adhesive comprises more than one thermoplastic polymer, copolymer, oligomer, as discussed below. A hot melt adhesive is thus molten at and above its melting temperature, but is solid at ambient temperature. A hot melt adhesive is tacky when molten. When molten, it can therefore act as an adhesive, or be easily applied to substrate(s). A hot melt adhesive may be tacky when molten and non-tacky when cooled and solid at ambient temperature (typically known in the art as non-pressure sensitive hot melt adhesives), or tacky when molten and remain tacky when cooled and solid at ambient temperature (typically known in the art as pressure sensitive hot melt adhesives).

Hot melt adhesives, and components thereof, are well known in the art. For example, ‘Sustainable Raw Materials in Hot Melt Adhesives: A Review; Vineeth et al.; Open Journal of Polymer Chemistry; Vol. 10, No. 3; August 2020’ and ‘Basic Study of Evaluation of Thermoplastic Polymers as Hot-Melt Adhesives for Mixed-Substrate Joining; Open Journal of Polymer Chemistry; Col. 6, No. 8; August 2016’ discuss hot melt adhesives.

In the context of the present invention, it will be appreciated that the hot melt adhesive acts as a vehicle for transfer of the colour-forming compound to the substrate or multi-layer substrate construction upon and/or within which colour and/or an image may be formed.

The hot melt adhesive of the composition of the first, second or third aspects of the present invention comprises a thermoplastic polymer, copolymer, oligomer, or mixtures thereof, as a base material. Typically, the hot melt adhesive further comprises a tackifier or resin. The hot melt adhesive typically also further comprise one or more additive components as described below. Preferably, the hot melt adhesive further comprises a tackifier or resin. Preferably, the hot melt adhesive further comprises one or more additive components.

The thermoplastic polymer, copolymer, oligomer, or mixture thereof, of the hot melt adhesive may be selected from, but not limited to the following: poly(ethylene-vinyl acetate) or ethylene-vinyl acetate copolymers; poly(ethylene acrylate) copolymers; acrylics; polyvinyl butyral; polyolefins such as polybutene, polyethylene, and polypropylene, including low-density (LDPE), medium-density (MDPE) and high-density (HDPE) polyethylene; polyamides such as ethylene diamine and hexamethylene diamine; nylon; polyesters including poly(lactic acid) (PLA), polyethylene terephthlate (PET), polyhydroxyalkanoates (PHA), and poly(glycolic acid) (PGA); polyurethanes; acrylic and styrene-acrylate copolymers; styrene-isoprene-styrene block tri- and copolymers; polystyrenes (PS); polycaprolactones; polycarbonates; fluoropolymers; elastomers; silicone rubbers and polypyrrole, or combinations thereof.

The thermoplastic polymer, copolymer, or oligomer may be a petro-plastic thermoplastic polymer, copolymer or oligomer, or a bio-plastic thermoplastic polymer, copolymer or oligomer. Preferably, the thermoplastic polymer, copolymer or oligomer is a bio-plastic thermoplastic polymer, copolymer or oligomer. The bio-plastic thermoplastic polymer, copolymer or oligomers encompassed herein include, but are not limited to: poly(lactic acid) (PLA), polyhydroxyalkanoates (PHA), and poly(glycolic acid) (PGA), as well as poly(ethylene-vinyl acetate) or ethylene-vinyl acetate (EVA) copolymers when formed from ethanol derived from sugarcane and/or other natural sources, and polyethylene when formed from sugarcane and/or other natural sources. For the poly(ethylene-vinyl acetate) or ethylene-vinyl acetate copolymers and polyethylene materials listed herein with respect to the thermoplastic polymer, copolymer, oligomer, or mixtures thereof, both bio-plastic and petro-plastic forms are encompassed.

As used herein, the prefix ‘petro-plastic’ refers to any material derived from a petrochemical source(s). Such materials are typically recyclable. They are therefore typically manufactured from either virgin or recycled materials, or a combination thereof.

As used herein, the prefix ‘bio-plastic’ refers to any material derived from a natural and sustainable source. Such materials are typically recyclable, biodegradable and/or compostable, in particular biodegradable and/or compostable. They are therefore typically manufactured from either virgin or recycled materials, or a combination thereof.

Preferably, the thermoplastic polymer, copolymer, oligomer, or mixture thereof, is recyclable, biodegradable and/or compostable.

Preferably, the thermoplastic polymer, copolymer, oligomer, or mixture thereof, is selected from polyethylene terephthalate (PET), polyhydroxyalkanoates (PHA), poly(glycolic acid) (PGA), poly(ethylene-vinyl acetate) or ethylene-vinyl acetate copolymer, low-density polyethylene (LDPE), medium-density polyethylene (MDPE), high-density polyethylene (HDPE), and poly(lactic acid) (PLA). More preferably, the thermoplastic polymer, copolymer, oligomer, or mixture thereof, is selected from polyhydroxyalkanoates (PHA), poly(glycolic acid) (PGA), poly(ethylene-vinyl acetate) or ethylene-vinyl acetate (EVA) copolymer, and low-density polyethylene (LDPE). More preferably, the thermoplastic polymer, copolymer, oligomer, or mixture thereof, is selected from a polyhydroxyalkanoates (PHA), poly(glycolic acid) (PGA), and a poly(ethylene-vinyl acetate) or ethylene-vinyl acetate (EVA) copolymer. Most preferably, the thermoplastic polymer, copolymer, oligomer is a poly(ethylene-vinyl acetate) or ethylene-vinyl acetate (EVA) copolymer.

The thermoplastic polymer, copolymer, oligomer, or mixture thereof, may be present in the hot melt adhesive in any suitable amount. Preferably, the thermoplastic polymer, copolymer, oligomer, or mixture thereof, is present in an amount of from 20 to 90%, such as from 30 to 80%, or from 40 to 75% of the hot melt adhesive.

The thermoplastic polymer, copolymer, oligomer, or mixture thereof, may be present in the compositions of the first, second or third aspects of the present invention in any suitable amount. Preferably, the thermoplastic polymer, copolymer, oligomer, or mixture thereof, is present in an amount of from 10 to 90%, such as from 20 to 70%, or even from 25 to 60% of the composition.

The hot melt adhesive of the compositions of the first, second or third aspects of the present invention may further comprise a tackifier or resin. Preferably, the hot melt adhesive of the compositions of the first, second or third aspects of the present invention comprises a tackifier or resin. It will be appreciated that more than one tackifier or resin may be present.

The tackifier or resin may comprise acid, hydroxyl or ester functional groups. Preferably, the tackifier or resin comprises acid or ester functional groups. When the tackifier or resin comprises acid functional groups, the tackifier or resin preferably has an acid group number of 5 to 250, such as 5 to 200.

Suitable tackifiers or resins include, but are not limited to the following: resins including natural resins such as copal, dammars, mastic and sandarac; petroleum resins; rosins and their derivatives such as rosins, rosin acids, rosin esters and rosin resins—gum rosin, wood rosin or tall oil rosin; hydrogenated rosins such as

Foral AX and Foral AX-E rosins from Eastman Chemical Companies; dimerised rosin resins; modified rosin resins; terpenes and modified terpenes; aliphatic, cycloaliphatic, and aromatic resins such as C5 aliphatic resins, C9 aromatic resins, and C5/C9 aromatic/aliphatic resins; hydrogenated hydrocarbon resins; terpene-phenol resins; polybutenes and polyisobutenes; and combinations thereof. Commercially available examples of tackifers or resins include ‘Piccotac 1020-E Hydrocarbon Resin’, ‘Piccotac 1095-N Hydrocarbon Resin’, ‘Piccotac 9095 Hydrocarbon resin’, ‘Piccotac 8095 Hydrocarbon resin’ available from Eastman Chemcial Companies. Preferably, the tackifier or resin is selected from rosins and their derivatives, hydrogenated rosins, dimerised rosin resins, and modified rosin resins.

The tackifier or resin may be present in the hot melt adhesive of the compositions of the first, second or third aspects of the present invention in any suitable amount. Preferably, when present, the tackifier or resin is present in an amount of from 1 to 90%, such as from 2 to 80%, or from 5 to 70%, or 10 to 60% of the hot melt adhesive.

The tackifier or resin may be present in composition of the first, second or third aspect of the present invention in any suitable amount. Preferably, when present, the tackifier or resin is present in an amount of from 10 to 90%, 15 to 80%, 20 to 70%, and preferably 25 to 60% of the composition.

The hot melt adhesive of the compositions of the first, second or third aspects of the present invention may further comprise one or more additive components. Preferably, the hot melt adhesive comprises one or more additive components. Suitable additive components will be well known to a person skilled in the art. These additive components will typically be present to manage the rheological properties, such as viscosity, of the hot melt adhesive, and thus the composition. Examples of suitable additive components include, but are not limited to the following: waxes such as fatty amide waxes, oxidised fischer-tropsch waxes or waxes dervies from both the Fischer-Tropsch and Zigler-Natta processes, water-soluble waxes, polyalkylene wax, mineral waxes such as paraffin and microcrystalline waxes, polyethylene waxes, polyethylene glycol waxes (Carbowax from DOW Chemical Inc.), oxidised polyethylene waxes, bisstearamides such as N, N′-ethylene bisstearamide (Acrawaz from Lonza Inc.), natural and synthetic waxes such as beeswax, soywax, carnuba, ozokerite and ceresin, and silicon waxes; slip additives; lubricants; inhibitors; antioxidants; stabilisers such as Irganox 1010; UV stabilisers and UV absorbers such as the Tinuvin series including Tinuvin 770, 928 326, 1130, (384-2) and 123, and combinations thereof (BASF); adhesion promotors; plasticisers such as glyceryl tribenzoate, alkyl benxoaes and benzoate esters (e.g. Benzoflex 9-88 from

Eastman Chemical Corporation), glycols like diethylene glycol, C12-15 alkyl benzoate, C2-C22 alkyl benzoates, alkyl citrates, phthalates, phthalate esters, paraffin oils, and polyisobutylene; light or energy absorbing agents; surfactants; wetting agents such as polyhydroxystearic acid, polyglyceryl-4 isostearate, hexyl laurate, esters like isopropyl myristate, propylene carbonate, isononyl isononanoate, glyceryl behenate/eicosadioate, trihydroxystearin, Cl2-15 alkyl benzoate, C2-C22 alkyl benzoates where the alkyl group is straight or branched or mixtures thereof, triethoxycaprylysilane, castor oil; drying promotors; colorants such as pigments; flame retardants; antistatic agents; fillers; tinting agents; viscosity modifiers; fluorescent agents; optical brighteners; oxidising or reducing agents; stabilisers; light stabilising agents such as hindered amines including Tinuvin 292; rheology modifiers such as thickening or thinning agents; matting agents; active clays; anti-settling agents; anti-sagging agents; dispersing agents; surface modification additives; slip additives; levelling agents; fillers; humectants; adhesion promotors; acid or base scavenging agents; retarders; defoamers; surfactants; antifoaming agents; biocides; preservatives; antioxidants such as BHT, phosphites and phosphates; antimicrobial agents; antiviral agents; antibacterial agents; antifungal agents; antimould agents; germicidal agents; sanitising agents; and combinations thereof. Typically, the hot melt adhesive further comprises one or more additive components selected from waxes, plasticisers, antioxidants, UV stabilisers, and fillers, or combinations thereof.

The one or more additive components may be present in the hot melt adhesive of the composition of the first, second or third aspect of the present invention in any suitable amount. Preferably, when present, the one or more additive components are present in an amount of from 0.1 to 35%, such as from 0.1 to 30%, or from 0.1 to 25%, or from 0.1 to 20% of the hot melt adhesive.

The one or more additive components may be present in the composition of the first, second or third aspect of the present invention in any suitable amount. Preferably, when present, the one or more additive components are present in an amount of from 0.1 to 35%, such as 0.1 to 30%, or even 0.1 to 25%, such as 0.1 to 20% of the composition.

It will be appreciated by a skilled person that the hot melt adhesive may be purchased commercially, or formulated from appropriate starting materials. Hot melt adhesives and components thereof are well known in the art. A skilled person in the art will be easily able to identify suitable hot melt adhesives, or required components such as thermoplastic polymers, oligomers, copolymers, or mixtures thereof, tackifiers or resins, and one of more additive components, depending on the desired properties of the hot melt adhesive in question. It will be further appreciated that hot melt adhesives and hot melt adhesive materials known in the art, such as those utilised in glue guns and hot glue applicators, are suitable for use in the present invention. Such materials are known by the skilled person.

Commercially available thermoplastic polymers, copolymers, oligomers, or mixtures thereof suitable for in the hot melt adhesive include, but are not limited to: poly(ethylene-vinyl acetate) or ethylene-vinyl acetate copolymers available from: ExxonMobil under the tradename ‘Escorene™ Ultra’; Rowak under the tradename ‘Rowalit® 300’; and Evatane as ‘SK functional polymers; Versalis S.p.A Greenflex HN70 from Distrupol; polypropylene from Borealis under the tradename ‘RE 420’; and low-density polyethylene available from Rowak under the tradename ‘Rowalit® H’ and from Lyondell Basell under the tradename ‘Lupolen 1800S’. Commercially available thermoplastic polymers, copolymers, oligomers, or mixtures thereof, for bio-based hot melt adhesives include, but are not limited to: polylactic acid (PLA), known as Ingeo™ Biopolymer 3251D from Nature Works (Minnetonka, MN, USA).

Commercially available hot melt adhesives suitable for use in the compositions of the first, second and third aspects of the present invention include, but are not limited to hot melt adhesives such as those available from Henkel (Technomelt, Technomelt Cool, Technomelt Supra, Technomlet Supra Pro, Technomelt Pur, Technomelt PA, Technomelt DA, Easymelt, and EasyFlow), Caswell Adhesives (Premiermelt or Casmelt products), Loctite, Bostik (Kizen, Kizen Force, Kizen ice, Kizen heat, Supergrip, Close TLH 4280E and TLH 2901E, Protect and Seal TLH 4492E, TLH 2299E, Send TLH 4280E, TLH 4119E, Track TLH 4000E, Show TLH 2211ELO, TLH 2299E, Hang TLH 2281E and TLH2211ELO, and TEF272), DuPont (ELVAX 40W, 150W, 210W, 220W, 240W, 250, 260, 265, 350, 360, 410, 420, 450, 460, 470, 550, 560, 660, 670, 750, 770, 4260, 4310, 4320 and 4355), Repsol (Primeva EVA's P1550M, P18150, P18500, P20020, P2430, P2735, P2870, P28025, P28150, P28400, P28045, P28800, P2850M, P2836M, P33015, P33025, P33045, P33400, P40055 with VA % 15 to 40 and Ebantix EBA's E1715, E1770, E20020, E27150, E33150 EBA (ethylene butyl acrylate) used with Tackifying Agents—Rosin Resins, Polyterpene Resins, Cycloaliphatic Aromatic Resins), Technology Supplied Ltd (‘Proflex 970 Hot Melt Glue Stick’), Tian Tian Adhesive Factory (‘Hot melt glue stick’), Toolstream Ltd (‘Hot melt Glue Stick’, 698462, 652076, 349348, 100024), FPC Corporation (‘Hot Melt Glue’, 501, 601, 701, 702, 707, 708, 7011, 724) and 3M (Hot Melt Adhesive 3764, 3747, 3748, 3731, 3738, 3796, 3792, 3762, 3779 and 3789).

The hot melt adhesive of the compositions according to the first, second or third aspects of the present invention may have any suitable melt flow index (MFI). The hot melt adhesive may have a melt flow index of from 1 to 1000 g/10 mins, such as from 3 to 900 g/10 mins or 10 to 900 g/10mins. It will be appreciated by a skilled person that the melt flow index defines the flowability of the hot melt adhesive when molten at and above its melting temperature.

Methods of measuring the melt flow index (MFI) of the hot melt adhesive will be well known to a skilled person, and values may be measured according to ISO standard 1133-1 or ASTM D1238. It will be appreciated that the term melt flow index may be used interchangeably with melt flow rate (MFR) or melt index (MI) by those in the art. Melt flow index is a measure of the rate of flow of a thermoplastic material such as a hot melt adhesive. It is defined as the mass of the thermoplastic material, in grams, that flows through a capillary of a specific diameter and length in 10 minutes on account of an applied pressure. In the context of the present invention, melt flow index is measured as a value which indicates the relative rate of flow of hot melt adhesives and the way that they behave when being heated to a temperature above ambient temperature that they become molten and are able to flow. The melt flow index of the hot melt adhesive may be roughly inversely proportional to the molecular weight of the thermoplastic polymer, copolymer, oligomer, or mixture thereof, of the hot melt adhesive. Melt flow index can be measured at different temperatures, with different weight loadings and different times, however MFI is commonly measured for 10 minutes, at temperatures of 190° C. and/or 230° C., and 2.16 kg or 5 kg weight. For example, a standard test uses an MFI apparatus, for example, an Extruson Plastometer for 10 minutes, at 190° C., and 2.16 kg weight. The applied load provides a shear stress in the apparatus setup.

The thermoplastic polymer, copolymer, oligomer, or mixture thereof, of the hot melt adhesive may have any suitable molecular weight. It will be appreciated by a skilled person that molecular weight can typically be indirectly assessed using MFI measurements, with generally a higher MFI corresponding to a lower molecular weight, and vice versa.

The melting temperature of the hot melt adhesive, may be from 50 to 200° C., or from 50 to 160° C., including from 70 to 150° C. The melting temperature of the hot melt adhesive is the temperature at which the hot melt adhesive becomes molten and able to flow. It is the temperature at which the hot melt adhesive transitions from a solid state into a viscous flow state. This may sometimes be known in the art as the softening temperature. It will be appreciated that the melting temperature is effectively the minimum processing temperature of the hot melt adhesive. As discussed above, the melting temperature of the hot melt adhesive may cover a melting temperature range. In the context of the present invention, both end points of any melting temperature range are encompassed by the stated values for the melting temperature of the hot melt adhesive.

Suitable methods for measuring the melting temperature of the hot melt adhesive will be well known to a skilled person. The melting temperature can be measured using melting point apparatus with a thermometer, differential scanning calorimetry (DSC), or by the known ‘Ring and Ball’ melting temperature measurement method. This may be according to ISO 4625-1:2020. In the ‘Ring and Ball’ method, a layer of hot melt adhesive layer is placed in a steel ring and cooled. A ball that fits through the ring is placed on top of this hot melt adhesive layer. The whole system is placed in an oil bath, and heated. The melting temperature is determined as the temperature when the ball falls through the hot melt adhesive layer and touches the bottom of the oil bath. Preferably, the melting point of the hot melt adhesive is measured by DSC. This may be according to ISO 11357-1:2016.

DSC is a technique well known to a skilled person, and is a thermoanalysis technique in which differences in the amount of heat energy necessary to change the temperature of a sample of hot melt adhesive and a comparative reference are measured as a function of temperature. The aim is for both the sample of hot melt adhesive and reference to maintain the same temperature so that DSC can determine the endothermic transition as the hot melt adhesive becomes molten and able to flow, i.e. the melting temperature. The underlying principle of DSC is that when the sample of hot melt adhesive undergoes physical transformation, more heat energy will be required to flow to the sample compared to the reference to maintain both at equal temperature. By measuring the difference in heat flow between the sample and reference, DSC is able to determine the amount of heat absorbed during the endothermic transition.

It will be appreciated that the hot melt adhesive, and thus the compositions of the first, second or third aspects of the present invention, are tacky when molten. The ‘tackiness’ of the hot melt adhesive, and thus the composition, may be measured according to ASTM3121 (‘Rolling Ball Tack’).

When the thermoplastic polymer, copolymer, oligomer, or mixture thereof, of the hot melt adhesive is a poly(ethylene-vinyl acetate) or ethylene-vinyl acetate copolymer, it will be appreciated by a skilled person that the ratio of vinyl acetate to ethylene in the copolymer may be varied. For example, the poly(ethylene-vinyl acetate) or ethylene-vinyl acetate copolymer may comprise from 1 to 60% of vinyl acetate, such as from 10 to 40%, or even from 15 to 33% of vinyl acetate. The poly(ethylene-vinyl acetate) or ethylene-vinyl acetate copolymer may comprise 25% or more vinyl acetate. The poly(ethylene-vinyl acetate) or ethylene-vinyl acetate copolymer may comprise 24% or less vinyl acetate.

It will be appreciated by a skilled person that alteration of the ratio of vinyl acetate to ethylene monomers on the backbone of the poly(ethylene-vinyl acetate) or ethylene-vinyl acetate copolymer structure may affect properties such as the bonding of the composition to the substrate, and thus the types of substrate to which the composition may be applied. For example, if the poly(ethylene-vinyl acetate) or ethylene-vinyl acetate copolymer comprises a high content of vinyl acetate (25% or greater), the composition is preferably applied to substrates having lower surface energies, such as polymeric films, which require a ‘tackier’ composition. On the other hand, if the poly(ethylene-vinyl acetate) or ethylene-vinyl acetate copolymer comprises a lower content of vinyl acetate (24% or less), the composition is preferably applied to substrates having higher surface energies, including porous or semi-porous substrates such as paper-based substrates including paper, card, cardboard and cartonboard, which require less ‘tacky’ compositions.

Preferably, the hot melt adhesive forms 20 to 80%, such as 30 to 70% of the composition of the present invention.

A colour-forming compound is admixed within the hot melt adhesive of the composition, and is thus homogeneously distributed, dispersed, suspended and incorporated throughout the hot melt adhesive to form the compositions of the first, second or third aspects of the present invention. The colour-forming compound is introduced into the hot melt adhesive in solid particulate form. By “colour-forming compound” is meant any suitable compound that forms colour upon exposure to radiation. By “colour” is meant the colours, tints, shades and hues of the visible light colour spectrum, i.e. red, orange, yellow, blue, green and violet, in addition to black, brown, turquoise, purple, pink, cyan, magenta, white and all mixtures thereof. All primary, secondary, tertiary, quaternary and quinary colours are encompassed, i.e. it will be appreciated that the colour formed by a colour-forming compound may be a primary, secondary, tertiary, quaternary or quinary colour. In the context of the invention, the term may also be used to describe differing shades of each of the colours of the visible light colour spectrum, in addition to black, brown, turquoise, purple, pink, cyan, white and magenta. It will be appreciated that in the context of the present invention, when the composition has a colour, the colour formed upon application of radiation to the composition of the present invention is different to, or has a stronger density than, the colour that the composition of the present invention may have upon formulation, storage, or application to or incorporation within a substrate or multi-layer substrate construction prior to the application of radiation thereto. The colour formed upon application of radiation to the composition of the present invention is different to, or has a stronger density than, the colour that those part(s) of the composition to which radiation is not applied may have. In the context of the present invention, following application of the composition of the present invention to a substrate or multi-layer substrate construction, or following its use in the formation of a multi-layer substrate construction, where the composition has a colour prior to the application of radiation, the colour-forming compound will form a contrasting colour upon controlled exposure of specific areas of the composition, and thus the colour-forming compound, to radiation from a laser source(s). By “contrasting colour” is meant that the colour formed by the colour-forming compound of the composition is distinct and easily differentiable from the background of the composition i.e. the part(s) of the composition that have not been exposed to the radiation, as well as any substrate visible through the part(s) of the composition that has not been exposed to radiation. The degree of effective formation of colour depends on the density of the colour formed in comparison to the surrounding area of the composition unexposed to radiation, as well as any substrate visible through the unexposed composition.

The colour-forming compound is in turn an image-forming compound, particularly suitable for forming images displaying variable information. By ‘image-forming compound’ is meant that, following application of the composition of the present invention to a substrate or multi-layer substrate construction, or following its use in the formation of a multi-layer substrate construction, the colour-forming compound will form colour and a discernible contrasting image on and/or within the substrate or multi-layer substrate construction upon controlled exposure of specific areas of the composition, and thus the colour-forming compound, to radiation. The image is human and/or machine readable. By “contrasting image” is meant that the image formed by the colour-forming compound of the composition is distinct and easily differentiable from the background of the composition i.e. the part(s) of the composition that have not been exposed to the radiation, as well as any substrate visible through the part(s) of the composition that has not been exposed to radiation. The degree of effective formation of colour or an image depends on the density of the colour or image formed in comparison to the surrounding area of the composition unexposed to radiation, as well as any substrate visible through the unexposed composition. It will be appreciated that in the context of the present invention, when the composition has a colour prior to the application of radiation, the colour of the image formed upon application of radiation to the composition of the present invention is different, or has a stronger density than, to the colour that the composition of the present invention may have upon formulation, storage, or application to or incorporation within a substrate or multi-layer substrate construction prior to the application of radiation thereto. The colour of the image formed upon application of radiation to the composition of the present invention is different to, or has a stronger density than, the colour that those part(s) of the composition to which radiation is not applied may have, and thus a contrasting image is formed.

The composition prior to application of radiation, and thus the background of the composition, may have any colour. Alternatively, the composition prior to the application or radiation, and thus the background of the composition, may be colourless.

The composition prior to the application of radiation, and thus, the background of the composition, may be transparent or opaque.

It will be appreciated that in the context of the present invention, the colour-forming compound preferably does not form colour until controlled and specific application of radiation to the composition. In some instances, the colour-forming compound may display some colour (‘background’) prior to the application of radiation to the composition. This may be as a result of temperatures reached during processing, manufacture or application of the composition to a substrate or multi-layer substrate construction. However, even in this case, the desired colour and/or image of the present invention may still be formed through subsequent application of radiation to the composition as application of the radiation causes the colour-forming compound to display colour of stronger density than the ‘background’ colour formed such that an effective and contrasting colour and/or image is still formed. Preferably, prior to the application of radiation to the composition, and in the part(s) of the composition to which radiation is not applied, the colour-forming compound does not display colour. Preferably, the colour-forming compound only displays colour in the part(s) of the composition to which radiation has been applied, i.e. the part(s) of the composition that have been exposed to radiation.

It will be appreciated that the colour-forming compound will be selected based upon the colour(s) of the compound that can be achieved, and the colour(s) desired in the image to be formed.

The colour forming compound may be selected from an oxyanion of a multivalent metal or oxyacid or hydrate thereof, and a leuco dye. It will be appreciated that more than one colour-forming compound may be present in the composition. Preferably, the colour-forming compound is an oxyanion of a multivalent metal or oxyacid or hydrate thereof.

### Oxyanion of a Multivalent Metal

The colour-forming compound may be an oxyanion of a multivalent metal, or an oxyacid or hydrate thereof. The hydrate may be of the oxyanion of the multivalent metal or corresponding oxyacid of the multivalent metal. The oxyanion of a multivalent metal or oxyacid thereof may also be anhydrous. The oxyanion of a multivalent metal or oxyacid or hydrate thereof may be any suitable oxyanion of a multivalent metal (anionic components) present in conjunction with a cationic counterpart. The use of oxyanions of multivalent metals in compositions is disclosed in U.S. Pat. No. 7,485,403, the content of which is incorporated herein by reference. The anionic component may be an inorganic metal oxyanion compound such as molybdate including di-, tri-, hexa-, hepta-, octa- and deca-molybdates, tungstate, chromate, or analogous transition metal compounds also in mixed oxidation states and of mixed inorganic metal oxyanions. Preferably, the accompanying cationic component is an alkali metal such as sodium, or an alkaline earth metal, or ammonium. One example of a preferred hydrate of an oxyanion of a multivalent metal is sodium molybdate dihydrate. Another example of a preferred hydrate of an oxyanion of a multivalent metal or oxyacid thereof is ammonium paratungstate. Preferred oxyanions of a multivalent metal are ammonium salts of inorganic metal oxyanion compounds. Particularly preferred as oxyanions of a multivalent metal are ammonium salts of oxyanions of molybdenum. A particularly preferred oxyanion of a multivalent metal is ammonium octamolybdate (NH₄)₄ Mo₈ O₂₆ or “AOM”, which is a commercially available molybdenum composition with the CAS number 12411-64-2.

Preferably, the oxyanion of a multivalent metal, or oxyacid or hydrate thereof is an oxyanion of a multivalent metal or hydrate of an oxyanion of a multivalent metal. More preferably, the oxyanion of a multivalent metal, or oxyacid or hydrate thereof is sodium molybdate dihydrate, or an ammonium salt of an oxyanion of a multivalent metal, such as an ammonium salt of an oxyanion of molybdenum. More preferably, the oxyanion of a multivalent metal, or oxyacid or hydrate thereof, is sodium molydbate dihydrate or ammonium octamolybdate (AOM). More preferably, the oxyanion of a multivalent metal, or oxyacid or hydrate thereof, is ammonium octamolybdate (AOM).

In the context of the present invention, when the oxyanion of multivalent metal, or oxyacid or hydrate thereof, is an ammonium salt of an oxyanion of a multivalent metal, such as an ammonium salt of an oxyanion of molybdenum, such as ammonium octamolybdate (AOM), the colour and/or image formed when an oxyanion of a multivalent metal, or oxyacid or hydrate thereof is utilised as the colour-forming compound will typically be black in colour, or a shade thereof, including greyscale depending on the density of the black colour formed by the radiation. The colour and/or image will be effective and human and/or machine visible. In such cases, other than being visually identifiable, the effective formation of colour or an image may be demonstrated by a measured absolute optical density (ODB) black value. This measures the density of the black colour of the image. In the context of ODB values, the higher the value, the darker the black colour formed. The ΔODB value (absolute ODB value—background ODB) may also be measured to demonstrate effective formation of colour or an image. The ‘background ODB’ is a measure of the background of the composition on the substrate i.e. the part(s) of the composition that have not been exposed to the radiation, as well as any substrate visible therethrough. The ΔODB value is thus a measure of the difference in optical density of the image and the unimaged part(s) of the composition. For the present invention, a ΔODB value of 0.5 or greater, preferably 0.7 or greater, such as 0.8 or greater and most preferably 1.0 or greater is desired. Such a value demonstrates formation of a high contrast image by the compositions of the present invention upon exposure to radiation. This quantifies the optical density on the black colour scale from low to high values, where ODB measurements can be made using a standard instrument densitometer and an X-Rite exact or SpectroEye spectrophotometer.

In the context of the present invention, when the oxyanion of multivalent metal, or oxyacid or hydrate thereof, is sodium molybdate dihydrate, the colour and/or image formed when an oxyanion of a multivalent metal, or oxyacid or hydrate thereof is utilised as the colour-forming compound will typically be white in colour, or a shade thereof. The colour and/or image will be human and/or machine visible. Without being bound by theory, the present inventors consider that, when sodium molybate dihydrate is utilised, upon application of radiation, preferably from a laser source(s), sodium molybdate dihydrate is dehydrated (thermally decomposes) to a dehydrated form. Without being bound by theory, the present inventors consider that the off-gassing or outgassing of water vapour (‘foaming’) from the sodium molybdate dihydrate generates microscopic pockets or bubbles resulting in a change in refractive index such that the composition displays a white colour following application of the radiation thereto.

For sodium molybdate dihydrate, other than being visually identifiable by a human and/or machine, the effective formation of colour and/or an image may be demonstrated by measurement of an opacity value. This may be used as a measure of the density of the colour and/or image. As used herein, opacity is a measure of the impenetrability of the composition to light, in this instance, visible light. Opacity is expressed as a percentage from transparent (0%) to opaque (100%). The percentage is a measure of the amount of light that does not pass through the composition, i.e. at 0% opacity, the composition is completely transparent as 0% of the light does not pass through the composition, and at 100% opacity, the composition is completely opaque as 100% of the light does not pass through the composition. In the context of the present invention, opacity values of both the areas of the composition to which radiation has been applied (image) and the areas of the composition to which the radiation has not been applied (background) can be measured in order to demonstrate the effective formation of a discernible human and/or machine-readable image. It will be appreciated by a skilled person that in the context of the present invention, the opacity of the image is greater than the opacity of the background, such that a discernible human and/or machine-readable image is formed. The greater the difference between the opacity values of the image and the background, the more distinct and discernible the image is.

When the oxyanion of a multivalent metal, or oxyacid or hydrate thereof is sodium molybdate dihydrate, the background of the composition, i.e. the part(s) of the composition to which the radiation has not been applied may have an opacity of 20% or less, such as from 15% or less, preferably 10% or less, or even 5% or less. Further, the areas of the composition to which the radiation has been applied and an image formed thereon may have an opacity of 40% or more, such as 45% or more, preferably 50% or more, or even 60% or more, such as 70% or more. It will be appreciated that the higher the opacity value of the image, the more distinct and discernible the image formed. A high opacity value thus denotes effective image formation.

In the context of the present invention, opacity measurements are made using the opacity function of a Techkon SpectroDens spectrophotometer according to ASTM standard ASTM D589-97, and the imaged (image) and unimaged (background) areas of the composition on the substrate or multi-layer substrate construction are each measured relative to black and white standards. First, the opacity function of the Techkon SpectroDens spectrometer is selected, the opacity of a composition on the substrate is then measured relative to a black Leneta chart, the opacity of the composition on the substrate or multi-layer substrate construction is then measured relative to a white background such as minimum 50 sheets of white paper, and the resulting opacity measurement displayed by the Techkon SpectroDens spectrometer.

The oxyanion of a multivalent metal or oxyacid or hydrate thereof, is introduced into and present in the composition in solid particulate form. The oxyanion of a multivalent metal, or oxyacid or hydrate thereof may comprise particles having a D₅₀ particle size distribution of 0.1 to 20 μm, such as 0.5 to 15 μm, or 0.5 to 10 μm and preferably 1 to 3 μm.

The term “D₅₀ particle size distribution” as used herein refers to the median particle diameter of the particles of the oxyanion of a multivalent metal, or oxyacid or hydrate thereof, i.e. the particle diameter above and below which 50% by number of the particle population is found.

It will be appreciated by a skilled person that particle size distribution measurements are made prior to incorporation of the oxyanion of a multivalent metal, or hydrate or oxyacid thereof, into the hot melt adhesive during formation of the composition. Particle size distribution measurements as specified herein are as measured by the conventional Malvern Mastersizer™ 3000 particle size analyser from Malvern Instruments in accordance with ISO 13320:2009.

The particles of the oxyanion of a multivalent metal of the present invention may have a surface area of 950 m²/kg or more, such as 1200 m²/kg or more, or 1500 m²/kg or more, preferably 2000 m²/kg or more, such as 2500 m²/kg or more, such as 3000 m²/kg or more, or even 3700 m²/kg, and more preferably 4000 m²/kg or more.

Surface area is measured using a Malvern Mastersizer according to ISO standard 13320:2009 that calculates the surface area from particle size distribution data.

The oxyanion of a multivalent metal or oxyacid or hydrate thereof, may have a decomposition temperature of from 80 to 700° C., or from 80 to 500° C., such as from 100 to 500° C., such as from 150 to 400° C., or even from 200 to 300° C. The decomposition temperature is the temperature at which the oxyanion of a multivalent metal or oxyacid or hydrate thereof, forms colour. The decomposition temperature of the oxyanion of a multivalent metal, or oxyacid or hydrate thereof, is the temperature at which the compound chemically decomposes. In some literature, this may also be known as the melting temperature. For sodium molybdate dihydrate, this is considered to be the temperature at which water is evaporated therefrom.

The decomposition temperature of ammonium octamolybdate (AOM) is 275° C. The decomposition temperature of sodium molybdate dihydrate is 100° C.

The decomposition temperature of the oxyanion of a multivalent metal or oxyacid or hydrate thereof, may be measured using differential scanning calorimetry (DSC), or thermogravimetric analysis (TGA). Preferably, the decomposition temperature is measured using DSC. This is a technique well known to a skilled person.

DSC is a technique well known to a skilled person, and is a thermoanalysis technique in which differences in the amount of heat energy necessary to change the temperature of a sample of the oxyanion of a multivalent metal and a comparative reference are measured as a function of temperature. The aim is for both the sample of the oxyanion of a multivalent metal and reference to maintain the same temperature so that DSC can determine the endothermic transition as the oxyanion of a multivalent metal decomposes, i.e. the decomposition temperature. The underlying principle of DSC is that when the sample of the oxyanion of a multivalent metal undergoes physical transformation, more heat energy will be required to flow to the sample compared to the reference to maintain both at equal temperature. By measuring the difference in heat flow between the sample and reference, DSC is able to determine the amount of heat absorbed during the endothermic transition.

The oxyanion of a multivalent metal or oxyacid or hydrate thereof, may be present in the composition according to the present invention in any suitable amount. Preferably, the oxyanion of a multivalent metal or oxyacid or hydrate thereof, is present in an amount of from 5 to 80%, such as from 10 to 70%, or from 20 to 60%, or from 25 to 55% of the composition.

### Leuco Dye

The colour-forming compound may be a leuco dye. Leuco dyes are well known to a skilled person as compounds capable of forming colour. Examples of suitable leuco dyes are contained in WO 2015/015200 and WO 2013/068729, the content of which is incorporated herein by reference. Suitable leuco dyes include, but are not limited to: any commercially available or chemically synthesisable leuco dye, including but not limited to: commercially available thermochromic and halochromic leuco dyes. Examples of suitable leuco dyes include, but are not limited to: spiroxazines, naphthopyrans, phthalides, fluorans, triarylmethanes, benzoxazines, quinazolines, spiropyrans, quinones, tetrazolium salts, thiazines, phenazines and oxazines, some of which are disclosed in WO 2006/108745, the content of which is incorporated herein by reference.

The leuco dye may be selected from: 3-di-n-butylamino-6-methyl-7-phenylaminofluoran (ODB-2: Wincon-2); 3-(N-ethyl-N-p-tolylamino)-6-methyl-7-anilinofluoran or 2-Anilino-6′-[ethyl(p-toyl)amino]-3′-methylspiro[isobenzofuran-1 (3H),9′-[9H]xanthene]-3-one (CAS No. 59129-79-2) (ETAC); 6-(Dimethylamino)-3,3-bis[4-(dimethylamino)phenyl]phthalide (Blue 12R-crystal violet lactone); and 3,3′-bis(1-n-octyl-2-methylindol-3-yl)phthalide (Red 16B).

Suitable suppliers of leuco dyes include, but are not limited to: Yamada Chemical Company Limited (Yamada), Chameleon Speciality Chemicals Limited, and Connect Chemicals.

Suitable leuco dyes from Yamada include, but are not limited to: GREEN 300 (fluoran); spiro[11H-[1]benzopyrano[2,3-g]quinolone-11,1′(3′H)-isobenzofuran]-3′-one, 1-ethyl-8-[ethyl(4-methylphenyl)amino]-1,2-dihydro-2,2,4-trimethyl (H-1046, fluoran) (CAS No. 140895-67-6); CVL (phthalide); BLUE 203 (pyridine blue); BLUE 220 (pyridine blue); BLMB (phenothiazine); RED 500 (fluoran); RED 520 (fluoran); RED 550 (fluoran); S-205 (fluoran); BLACK 305 (fluoran); BLACK 400 (fluoran); BLACK 100 (fluoran); and NIR BLACK 78 (divinyl phthalide).

The leuco dye may further be selected from: 2-Anilino-3-diethylamino-6-methylfluoran (Chameleon Black 1), 2-Anilino-6-dibutylamino-3-methylfluoran (Chameleon Black 2), 6-(Dimethylamino)-3,3-bis[4-(dimethylamino) phenyl]phthalide (Chameleon Blue 3), 4,4′-[(9-butyl-9H-carbazol-3-yl)methylene]bis[N-methyl-N-phenylaniline] (Chameleon Blue 4), 3,3′-Bis(1-n-octyl-2-methylindol-3-yl)phthalide (Chameleon Red 5), 6′-(Diethylamino)-3-oxo-spiro[isobenzofuran-1(3H), 9′-[9H]xanthene]-2′-carboxylic acid ethyl ester (Chameleon Orange 6), 7-[4-(diethylamino)-2-ethoxyphenyl]-7-(2-methyl-1-octyl-1H-indol-3-yl) Furo[3,4-b]pyridin-5(7H)-one (Chameleon Blue 8), 2′-(Dibenzylamino)-6′-(diethylamino) fluoran (Chameleon Green 9), N, N-dimethyl-4-[2-[2-(octyloxy)phenyl]-6-phenyl-4-pyridinyl]-Benzenamine (Chameleon 10), 6′-(diethylamino)-2′-[(dimethylphenyl)amino]-3′-methylspiro[isobenzofuran-1(3H), 9′-[9H]xanthene]-3-one (Chameleon Black 15), 2′-Anilino-6′-(dibutylamino)-3′-methyl-3H-spiro[2-benzofuran-1,9′-xanthen]-3-one (CAS No. 89331-94-2) (ODB-2/Wincon-2), 6′-(Diethylamino)-3′-methyl-2′-(phenylamino)spiro[2-benzofuran-3,9′-xanthene]-1-one (ODB-1/Wincon-1) (CAS No. 29512-49-0), 2-Anilino-6′-[ethyl(p-toyl)amino]-3′-methylspiro[isobenzofuran-1 (3H),9′-[9H]xanthene]-3-one (CAS No. 59129-79-2), 6-(dimethylamino)-3,3-bis-[4-(dimethylamino)phenyl) phthalide (Blue3-CVL, CAS No 1522-42-7), 4,4′-[(9-butyl-9H-carbazol-3-yl)methylene]bis[N-methyl-N-phenylaniline] (Blue-4, CAS No 67707-04-4), 3,3′-Bis(1-n-octyl-2-methylindol-3-yl)phthalide (Red-5, CAS No 50292-95-0), 6′-(Diethylamino)-3-oxo-spiro[isobenzofuran-1(3H), 9′-[9H]xanthene]-2′-carboxylic acid ethyl ester (Orange-6, CAS No 154306-60-2), 7-[4-(diethylamino)-2-ethoxyphenyl]-7-(2-methyl-1-octyl-1H-indol-3-yl) Furo[3,4-b]pyridin-5(7H)-one (Blue-8, CAS No 87563-89-1), 2′-(Dibenzylamino)-6′-(diethylamino)fluoran (Green-9, CAS No 34372-72-0), N,N-dimethyl-4-[2-[2-(octyloxy)phenyl]-6-phenyl-4-pyridinyl]-Benzenamine (Yellow-10, CAS No 144190-25-0), 6′-(diethylamino)-2′-[(dimethylphenyl) amino]-3′-methylspiro[isobenzofuran-1(3H), 9′-[9H]xanthene]-3-one (Black-15, CAS No 36431-22-8), 2-Anilino-3-diethylamino-6-methylfluoran, 2-Anilino-6-dibutylamino-3-methylfluoran, 6-(Dimethylamino)-3,3-bis[4-(dimethylamino) phenyl]phthalide, 4,4′-[(9-butyl-9H-carbazol-3-yl)methylene]bis[N-methyl-N-phenylaniline], 3,3′-Bis(1-n-octyl-2-methylindol-3-yl)phthalide, 6′-(Diethylamino)-3-oxo-spiro[isobenzofuran-1(3H), 9′-[9H]xanthene]-2′-carboxylic acid ethyl ester, 7-[4-(diethylamino)-2-ethoxyphenyl]-7-(2-methyl-1-octyl-1H-indol-3-yl) Furo[3,4-b]pyridin-5(7H)-one, 2′-(Dibenzylamino)-6′-(diethylamino)fluoran, N,N-dimethyl-4-[2-[2-(octyloxy)phenyl]-6-phenyl-4-pyridinyl]-Benzenamine, and 6′-(diethylamino)-2′-[(dimethylphenyl) amino]-3′-methylspiro [isobenzofuran-1(3H),9′-[9H]xanthene]-3-one, 4,4′-[(9-butyl-9H-carbazol-3-yl)methylene]bis[Nmethyl-N-phenylaniline] (CAS No. 67707-04-4), 6′-(diethylamino)-3-oxospiro[isobenzofuran-1(3H), 9′-(9H)xanthene]-2′carboxylic acid ethyl ester (CAS No. 154306-60-2), and 2′-(dibenxylamino)-6′-(diethylamino)fluoran (CAS No. 34372-72-0).

Preferably, the leuco dye is selected from 2′-Anilino-6′-(dibutylamino)-3′-methyl-3H-spiro[2-benzofuran-1,9′-xanthen]-3-one (ODB-2, CAS No. 89331-94-2), 6′-(Diethylamino)-3′-methyl-2′-(phenylamino)spiro[2-benzofuran-3,9′-xanthene]-1-one (CAS No. 29512-49-0), and 2-Anilino-6′-[ethyl(p-toyl)amino]-3′-methylspiro[5isobenzofuran-1(3H), 9′-[9H]xanthene]-3-one (ETAC) (CAS No. 59129-79-2). Preferably, the leuco dye is 2′-Anilino-6′-(dibutylamino)-3′-methyl-3H-spiro[2-benzofuran-1,9′-xanthen]-3-one (ODB-2, CAS No. 89331-94-2) or 2-Anilino-6′-[ethyl(ptoyl)amino]-3′-methylspiro[isobenzofuran-1 (3H), 9′-[9H]xanthene]-3-one (ETAC) (CAS No. 59129-79-2).

The leuco dye may have a melting temperature of from 80 to 220° C., such as from 100 to 220° C., or even from 160 to 210° C. In the context of a leuco dye, this is the temperature at which the leuco dye forms colour. As discussed below, the leuco dye forms colour when the accompanying thermal acid-generating agent is also in the same liquid state (discussed in more detail below). In the context of a leuco dye, melting temperature refers to the temperature at which the leuco dye transitions from a solid particulate form (solid state) to a liquid state, i.e. melts.

The melting temperature of the leuco dye may be measured using melting point apparatus with a thermometer or differential scanning calorimetry (DSC). Preferably, the melting temperature is measured using DSC. This is a technique well known to a skilled person.

DSC is a technique well known to a skilled person, and is a thermoanalysis technique in which differences in the amount of heat energy necessary to change the temperature of a sample of the leuco dye and a comparative reference are measured as a function of temperature. The aim is for both the sample of the leuco dye and reference to maintain the same temperature so that DSC can determine the endothermic transition as the leuco dye melts, i.e. the melting temperature. The underlying principle of DSC is that when the sample of the leuco dye undergoes physical transformation, more heat energy will be required to flow to the sample compared to the reference to maintain both at equal temperature. By measuring the difference in heat flow between the sample and reference, DSC is able to determine the amount of heat absorbed during the endothermic transition.

The melting temperature of 2′-Anilino-6′-(dibutylamino)-3′-methyl-3H-spiro[2-benzofuran-1,9′-xanthen]-3-one (ODB-2, CAS No. 89331-94-2) is 183° C. The melting temperature of 2-Anilino-6′-[ethyl(ptoyl)amino]-3′-methylspiro[isobenzofuran-1 (3H), 9′-[9H]xanthene]-3-one (ETAC) (CAS No. 59129-79-2) is 206° C.

In the context of the present invention, the image formed when a leuco dye is utilised as the colour-forming compound of the composition may be of any appropriate colour. For example, the image may be formed of a colour selected from red, blue, green, orange, yellow and black, or a shade thereof. When the colour is black, or a shade, thereof, this includes greyscale depending on the density of the black colour formed by the radiation. It will be appreciated that the specific leuco dye will be selected depending upon the colour required for the image on the substrate.

When a leuco dye is utilised as the colour-forming compound of the composition, the effective formation of colour and/or an image may be demonstrated by a measured optical density value. The colour and/or image will be human and/or machine visible. For black colour formation, this is a measured absolute optical density black (ODB) value, as discussed above for the oxyanion of a multivalent metal, or oxyacid or hydrate thereof. For red colour formation, effective image formation is measured by an absolute optical density magenta (ODM) value. This measures the density of the red colour of the image. For blue colour formation, effective image formation is measured by an absolute optical density cyan (ODC) value. This measures the density of the blue colour of the image. For yellow colour formation, this is measured by an absolute optical density yellow (ODY) value. This measures the density of the yellow colour of the image. In the context of ODM, ODC and ODY values, the higher the value, the darker the respective red, blue or yellow colour formed. The ΔODB, ΔODM, ΔODC and ΔODY values may also be measured to demonstrate effective formation of colour or an image, in the same way as detailed above for the ΔODB of the oxyanion of a multivalent metal, or oxyacid or hydrate thereof. For the present invention, a ΔODB, ΔODM, ΔODC or ΔODY value of 0.5 or greater, preferably 0.7 or greater, such as 0.8 or greater, and most preferably 1.0 or greater is desired. Such values demonstrates formation of a high contrast image by the compositions of the present invention upon exposure to radiation. ODB, ODM, ODC and ODY values can be measured using a standard instrument densitometer and an X-Rite exact or SpectroEye spectrophotometer.

For the composition according to the first, second or third aspects of the present invention, when the colour-forming compound is a leuco dye, the leuco dye is accompanied in the composition by a thermal acid-generating agent (TAG). In such instances, the hot melt adhesive of the composition of the present invention therefore further has a thermal acid-generating agent admixed therein, and thus distributed throughout, when the colour-forming compound is a leuco dye.

It will be appreciated by a skilled person that the thermal acid-generating agent and leuco dye interact and react to achieve colour formation. Without being bound by theory, the present inventors consider that colour formation is facilitated when the leuco dye and thermal acid-generating agent melt from solid particulate form (solid state) into the same liquid state. In the context of the present invention, without being bound by theory, the present inventors consider that such interaction of the thermal acid-generating agent with the leuco dye occurs upon application of radiation to the composition, when both the leuco dye and the thermal acid-generating agent are in the same liquid state.

Suitable thermal acid-generating agents include any suitable commercially available or chemically synthesisable thermal acid-generating agents. Suitable thermal acid-generating agents include, but are not limited to the following: 4-Hydroxyphenyl-4′-isopropoxyphenyl sulfone (Chameleon Developer-1); N-(p-toluenesulfonyl)-N′-(3-(p-toluenesulfonyloxy)phenyl)urea (Pergafast 201); 1,1,1-Tris(4-Hydroxyphenyl) Ethane (THPE) and thermal acid-generating agents based on amine salts of borobenzylate and tri-n-butylammonium borodisalicylate such as tri-n-butylammonium-4,4′-dioxo-4H,4′H-2,2′-spirobi[benzo[d][1,3,2]dioxaborinin]-2-uide or N, N-dibutylbutan-1-aminium bis[2-(hydroxy-kO)benzoato(2-)-kO]borate(1-), as well as 4-hydroxy-4′-(2,4-dihydroxyphenyl)phenylmethanone, isopropoxydiphenylsulfone, 3-(3-tosylureido)phenyl-4-methylbenzenesulfonate, propyl-3,4,5-trihydroxybenzoate and 4,4′-methanediyldiphenol.

Preferably, the thermal acid-generating agent is selected from 1,1,1-Tris(4-Hydroxyphenyl) Ethane (THPE), tri-n-butylammonium-4,4′-dioxo-4H,4′H-2,2′-spirobi[benzo[d][1,3,2]dioxaborinin]-2-uide, N, N-dibutylbutan-1-aminium bis[2-(hydroxy-kO)benzoato(2-)-kO]borate(1-), 4-hydroxy-4′-isopropoxydiphenylsulfone, (2,4-dihydroxyphenyl)phenylmethanone, 3-(3-tosylureido)phenyl-4-methylbenzenesulfonate, propyl-3,4,5-trihydroxybenzoate and 4,4′-methanediyldiphenol. More preferably, the thermal acid-generating agent is selected from 1,1, 1-Tris(4-Hydroxyphenyl)Ethane (THPE) and N,N-dibutylbutan-1-aminium bis[2-(hydroxy-kO)benzoato(2-)-kO]borate(1-). More preferably, the thermal acid-generating agent is 1,1,1-Tris(4-Hydroxyphenyl)Ethane (THPE).

The thermal acid-generating agent may have a melting temperature of from 100 to 270° C., such as from 110 to 250° C. In the context of a thermal acid-generating agent, the melting temperature is the temperature at which the thermal acid-generating agent transitions from a solid particulate form (solid state) to a liquid state, i.e. melts. As discussed in more detail herein, this is the temperature at which the thermal acid-generating agent has the capability to enable the leuco dye to form colour, if the accompanying leuco dye is also in the same liquid state.

The melting temperature of the thermal acid-generating agent may be measured using melting point apparatus with a thermometer, or differential scanning calorimetry (DSC). Preferably, the melting temperature is measured using DSC. This is a technique well known to a skilled person.

DSC is a technique well known to a skilled person, and is a thermoanalysis technique in which differences in the amount of heat energy necessary to change the temperature of a sample of the thermal acid-generating agent and a comparative reference are measured as a function of temperature. The aim is for both the sample of the thermal acid-generating agent and reference to maintain the same temperature so that DSC can determine the endothermic transition as the thermal acid-generating agent melts, i.e. the melting temperature. The underlying principle of DSC is that when the sample of the thermal acid-generating agent undergoes physical transformation, more heat energy will be required to flow to the sample compared to the reference to maintain both at equal temperature. By measuring the difference in heat flow between the sample and reference, DSC is able to determine the amount of heat absorbed during the endothermic transition.

The melting temperature of 1,1,1-Tris(4-Hydroxyphenyl)Ethane (THPE) is from 244 to 248° C. The melting temperature of N,N-dibutylbutan-1-aminium bis [2-(hydroxy-kO)benzoato(2-)-kO]borate(1-) is 139° C.

It will be appreciated that the thermal acid-generating agent is also introduced into the hot melt adhesive in solid particulate form during formation of the composition.

The leuco dye may be present in the composition according to the first, second or third aspects of the present invention in any suitable amount. Preferably, the leuco dye is present in an amount of from 5 to 80%, such as 10 to 40% of the composition.

When the colour-forming compound is a leuco dye, the thermal acid-generating agent may be present in the composition according to the first, second or third aspect of the present invention in any suitable amount. Preferably, when the colour-forming compound of the composition according to the first, second or third aspects of the present invention is a leuco dye, a thermal acid-generating agent may be present in an amount of from 10 to 80%, such as from 15 to 50% of the composition.

It will be appreciated by a skilled person that during formulation of the composition according to the first, second or third aspects of the present invention, i.e. incorporation of the colour-forming compound into the hot melt adhesive, or during application of the composition to a substrate or multi-layer substrate construction, and/or its use in the formation of a multi-layer substrate construction, the hot melt adhesive is required to be molten such that it can flow. This is achieved by heating of the hot melt adhesive, and thus the composition, to or above, preferably above, the melting temperature of the hot melt adhesive. As discussed above, it will be appreciated by a skilled person that this may encompass a melting temperature range. It will be appreciated by a skilled person that, in order that colour and/or an image can be formed on the composition following these formulation or application stages through the application of radiation, the melting or decomposition temperature of the colour-forming compound, including, if present, the melting temperature of the thermal acid-generating agent, is not reached. Accordingly, in order that colour and/or an image can be formed on the composition following these formulation or application stages through the application or radiation, during the heating in either of the formulation or application stages, appropriate selection of the hot melt adhesive and colour-forming compound is necessary. Such selection is dependent upon the relationship between the melting temperature of the hot melt adhesive, and the melting or decomposition temperature of the colour-forming compound, including, if present, the melting temperature of the thermal acid-generating agent.

For the composition according to the first, second or third aspects of the present invention, the melting temperature of the hot melt adhesive is lower than the temperature at which the colour-forming compound forms colour, i.e. the melting temperature of the hot melt adhesive is lower than the melting or decomposition temperature of the selected colour-forming compound, as well as the melting temperature of the thermal acid-generating agent, when present.

When an oxyanion of a multivalent metal, or oxyacid or hydrate thereof, is utilised as the colour-forming compound of the composition according to the present invention, the decomposition temperature of the oxyanion of a multivalent metal, or oxyacid or hydrate thereof is greater than the melting temperature of the hot melt adhesive. Accordingly, the hot melt adhesive, or the composition, may be heated to a temperature at or above, preferably above, the melting temperature of the hot melt adhesive such that the hot melt adhesive becomes molten and suitable for application to a substrate, multi-layer substrate construction, or substrate of a multi-layer construction. However, this temperature is below the decomposition temperature of the oxyanion of a multivalent metal, or oxyacid or hydrate thereof. Accordingly, colour and/or image formation can be controlled and achieved through the application of radiation to the composition when subsequently required.

It will be appreciated that for the composition of the third aspect of the present invention when the colour-forming compound is ammonium molybdate (AOM), or the specified leuco dyes, the decomposition or melting temperatures of these colour-forming compounds are higher than the melting temperature of the hot melt adhesive at from 50 to 200° C., or from 50 or 160° C., including from 70 to 150 ° C., as detailed herein.

When a leuco dye is utilised as the colour-forming compound of the composition according to the first, second or third aspects of the present invention accompanied by a thermal acid-generating agent, the melting temperature of both of the leuco dye and thermal acid-generating agent is greater than the melting temperature of the hot melt adhesive of the composition. This is to ensure that both the leuco dye and thermal acid-generating agent remain in a solid particulate form when the melting temperature of the hot melt adhesive is reached. This is to avoid colour formation which would prevent formation of colour and/or an image by the subsequent application of radiation caused by interaction between the leuco dye and thermal acid-generating agent. Without being bound by theory, colour formation is facilitated when the leuco dye and thermal acid-generating agent melt from solid particulate form (solid state) into the same liquid state, i.e. when one or both the melting temperature of the leuco dye and the melting temperature of the thermal acid-generating agent have been reached and the leuco dye and thermal acid-generating agent are able to intimately interact and react in the same liquid phase. Accordingly, the hot melt adhesive, or the composition, may be heated to a temperature at or above, preferably above, the melting temperature of the hot melt adhesive such that the hot melt adhesive becomes molten and suitable for application to a substrate, multi-layer substrate construction, or substrate of a multi-layer substrate construction, but this temperature is below the melting temperature of both the leuco dye and thermal acid-generating agent. Accordingly, colour and/or image formation can be controlled and achieved through the application of radiation to the composition when subsequently required.

It will therefore be appreciated that the hot melt adhesive, colour-forming compound and if present, the thermal acid-generating agent, will be selected dependent upon their respective melting or decomposition temperatures, and the relationship therebetween, as appropriate. Colour formation which would prevent formation of colour and/or an image through the application of subsequent radiation is therefore avoided during manufacturing, processing and application of the composition of the present invention to the substrate, multi-layer substrate construction, or in the formation of the multilayer substrate construction, prior to the application of controlled radiation to facilitate formation of the desired colour or image.

It will further be appreciated by a skilled person that if the composition according to the first, second or third aspects of the present invention comprises more than one colour-forming compound, both of the colour-forming compounds will have to conform to the relationships stated above.

It will be appreciated by a skilled person that although the ranges for the melting or decomposition temperature of the colour-forming compounds and melting temperature of the thermal acid-generating agent detailed herein overlap with those of the melting temperatures of the hot melt adhesive detailed herein, the hot melt adhesive, colour-forming compound and where present, the thermal acid-generating agent of the composition of the present invention are selected so as to maintain the relationships stated above.

It will be appreciated by a skilled person that the present invention encompasses a composition wherein the hot melt adhesive is molten during manufacture, processing and application, as well as a composition wherein the hot melt adhesive is in a solid state (when cooled to ambient temperature) during storage, or following application of the composition to a substrate or multi-layer substrate construction.

The hot melt adhesive of the composition according to the first or third aspects of the present invention may further have an infrared radiation absorbing compound admixed therein. Preferably, the hot melt adhesive of the composition according to the first or third aspects of the present invention has an infrared radiation absorbing compound admixed therein.

The hot melt adhesive of the composition according to the second aspect of the present invention further has an infrared radiation absorbing compound admixed therein.

As for the colour-forming compound, the infrared radiation absorbing compound is homogeneously distributed, dispersed, suspended and incorporated throughout the hot melt adhesive of the composition. More than one infrared radiation absorbing compound may be present. It will be appreciated that an infrared radiation absorbing compound is typically included when infrared (IR) radiation including near-infrared (NIR) radiation is to be utilised in the formation of colour and/or an image. The infrared radiation absorbing compound is capable of enhancing absorption of the IR radiation and thus enhancing the colour and/or image formed. Examples of suitable infrared radiation absorbing compounds include, but are not limited to the following: inorganic copper salts such as copper (II) hydroxyl phosphate (CHP); organic NIR dyes and pigments, such as N,N,N′,N′-tetrakis(4-dibutylaminophenyl)-p-benzoquinone bis(iminium hexafluoro-antimonate); non-stoichiometric, reduced or doped inorganic compounds such as reduced indium tin oxide, reduced zinc oxide, reduced tungsten oxide, reduced doped tungsten oxide including an inorganic compound of the following formula MxWyOz (where M is at least one element selected from the group consisting of H, He, alkali metal, alkaline earth metal, rare earth element, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi and I, W is tungsten, O is oxygen, satisfying 0.001≤x/y≤1; and 2.2≤z/y≤3.0.), reduced antimony tin oxide, or doped metal oxides such as aluminium-doped zinc oxide (AZO) and fluorine-doped tin oxide (FTO); conductive polymers such as poly polystyrene sulfonate (PEDOT); and combinations thereof.

Preferably, the infrared radiation absorbing compound is selected from inorganic copper salts such as copper (II) hydroxyl phosphate (CHP), and non-stoichiometric, reduced or doped inorganic compounds such as reduced indium tin oxide, reduced zinc oxide, reduced tungsten oxide, reduced doped tungsten oxide including an inorganic compound of the following formula MxWyOz (where M is at least one element selected from the group consisting of H, He, alkali metal, alkaline earth metal, rare earth element, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi and I, W is tungsten, O is oxygen, satisfying 0.001≤x/y≤1; and 2.2≤z/y≤3.0.).

When present, the infrared radiation absorbing compound may be present in the composition according to the present invention in any suitable amount. Preferably, the infrared radiation absorbing compound forms 0.1 to 33% of the composition, such as from 0.5 to 30% of the composition.

The infrared radiation absorbing compound is introduced into the composition in solid particulate form. When present in the composition, the infrared radiation absorbing compound is present in solid particulate form.

It will be appreciated by a skilled person that when an infrared radiation absorbing compound is present, the radiation used to form colour or an image on the composition will preferably be IR radiation.

The composition of the present invention does not comprise a solvent or water. There is no water or solvent present in either the hot melt adhesive or the composition of the present invention.

The composition of the present invention is a radiation-reactive composition, a laser-reactive composition, i.e. capable of forming colour and/or an image upon application of radiation to the composition, preferably from a laser source(s).

The composition according to the present invention may be applied to any suitable substrate. It will be appreciated that the contents of the composition will likely vary depending on the substrate to which the composition is to be applied.

Thus, according to a fourth aspect of the present invention, there is provided a substrate comprising the composition according to the first, second or third aspect of the present invention applied thereon.

For the fourth aspect of the present invention, the composition may have any of the features described as preferred or optional with regard to any of the other aspects of the present invention.

Examples of suitable substrates to which the composition may be applied include, but are not limited to: polymers and recycled polymer materials such as polyhydroxyalkanoates (PHA), poly(glycolic acid) (PGA), polyethylene terephthalate (PET), poly(ethylene vinyl-acetate) or ethylene-vinyl acetate copolymers, polyethylene (PE), low density polyethylene (LDPE), high density polyethylene (HDPE), polystyrene (PS), polypropylene (PP), orientated polypropylene (OPP), biaxially orientated polypropylene (BOPP), cast polypropylene (CPP), polyamide (PA) such as nylon, polyvinyl chloride (PVC), or combinations thereof; cellulose; glass; plastic; metal and metal foils such as tinplate; textiles; paper-based substrates including paper, card, carton, paperboard, cartonboard, corrugated paper, corrugated card, corrugated carton, corrugated paperboard, cardboard, corrugated cartonboard, folding carton and equivalent recycled analogues, or combinations thereof; ceramics; foodstuffs and pharmaceutical preparations; or combinations thereof, e.g. polymer lined paper or polymer impregnated paper. Suitable substrates include multi-layer substrates formed from the materials and substrates listed above. The polymer and recycled polymer materials may be in the form of polymer foil or film substrates.

Preferably the substrate to which the composition is applied is a recyclable, biodegradable and/or compostable substrate.

The substrate according to the fourth aspect of the present invention may be bonded to an additional substrate using the composition, for example when the hot melt adhesive, and thus the composition on the substrate, is tacky at ambient temperature. Additional substrates may be as detailed above for the substrate according to the fourth aspect of the present invention. Multi-layer substrate constructions may be formed in this way.

In the context of the present invention, when the thermoplastic polymer, copolymer, oligomer, or mixture thereof, of the hot melt adhesive is a bio-plastic thermoplastic polymer, copolymer, oligomer, or mixture thereof, the substrate to which the composition is applied is preferably formed of a bio-plastic material. Similarly, when the thermoplastic polymer, copolymer, oligomer, or mixture thereof, of the hot melt adhesive is a petro-plastic polymer, copolymer, oligomer, or mixture thereof, the substrate to which the composition is applied is preferably formed of a petro-plastic material. The bio-plastic materials encompassed herein include, but are not limited to: poly(lactic acid) (PLA), polyhydroxyalkanoates (PHA), and poly(glycolic acid) (PGA), as well as poly(ethylene-vinyl acetate) or ethylene-vinyl acetate copolymers when formed from ethanol derived from sugarcane and/or other natural sources, and polyethylene when formed from sugarcane and/or other natural sources. For the poly(ethylene-vinyl acetate) or ethylene-vinyl acetate copoylmers and polyethylene materials listed herein with respect to the substrate, both bio-plastic and petro-plastic forms are encompassed.

The substrate to which the composition is applied may have a thickness of from 12 μm to 5 mm, such as from 12 μm to 500 μm. In particular, when the substrate is a paper-based substrate, the paper-based substrate may have a weight per unit area (gsm) of from 50 to 500 gsm, such as from 60 to 250 gsm, and including from 80 to 200 gsm.

It will be appreciated that the substrate may comprise a single or multiple layers of the composition according to the present invention applied thereto. Preferably, only a single later of the composition is required. This is advantageous with respect to the multiple layers of composition that are necessary to achieve effective colour and/or image formation in conventional printing processes.

The composition according to the present invention is preferably directly applied to the substrate.

For the substrate according to the present invention, the composition may be applied to all, substantially all or part of the surface area of a surface thereof.

Preferably, the composition is applied to an exterior surface of the substrate, such that it is exposed, i.e. there is no layer, such as protective layer or otherwise, overlying the composition.

When the substrate is utilised in the formation of a product as discussed below, the composition may be present on any surface thereof, interior or exterior.

It will be appreciated that the fourth aspect of the present invention encompasses substrates having a composition applied thereto, wherein the composition has just been applied and is molten, i.e. prior to it cooling to ambient temperature. The fourth aspect of the present invention also encompasses substrates having a composition applied thereto, wherein the composition is solid at ambient temperature. This composition may be tacky or non-tacky at ambient temperature.

For the substrate according to the present invention, it will be appreciated that prior to the application of radiation, the colour-forming compound of the composition applied to the substrate will preferably not display colour.

According to a fifth aspect of the present invention, there is provided a multi-layer substrate construction comprising the composition according to the first, second or third aspects of the present invention applied thereon and/or incorporated therein.

For the fifth aspect of the present invention, the composition may have any of the features described as preferred or optional with regard to any of the other aspects of the present invention.

The multi-layer substrate construction may be formed of at least two substrates, bonded together with the composition. For such multi-layer substrate constructions, the composition may be utilised to adhere the substrates together such that it is between the at least two substrates and incorporated within the multi-layer substrate construction. Alternatively, the multi-layer substrate construction may be formed of at least two substrates and have the composition according to the present invention applied to a surface thereof. It will be appreciated that the multi-layer construction may comprise further substrates bonded to the at least two substrates discussed above, said further substrate(s) being bonded by the same or typically, other adhesives without colour-forming compounds admixed therein. Other adhesives will be well known to a skilled person.

For the fifth aspect of the invention, each of the substrates of the multi-layer substrate construction may be formed of one of the substrates described above in relation to the third aspect of the present invention.

Typically, the multi-layer substrate construction according to the fifth aspect of the present invention is formed of at least two substrates (formed of substrates as described above in relation to the fourth aspect of the present invention), the at least two substrates having the composition according to the present invention sandwiched therebetween. It will therefore be appreciated that the composition is utilised to bond the two substrates together. It will be appreciated that in such instances, the composition should still be visible, for example typically at least one of the substrates is transparent or translucent, for example a polymeric film, such that any colour and/or image formed is visible and human and/or machine readable.

It will be appreciated that in the formation of the multi-layer substrate construction of the present invention, the composition may be applied to the multi-layer substrate construction or to one of the at least two substrates prior to bonding to the other to form the multi-layer substrate construction, in a single or multiple layers, preferably a single layer.

It will be appreciated that in the formation of the multi-layer substrate construction according to the present invention, the composition may be applied to all, substantially all or part of the surface area of the multi-layer substrate construction or to the substrate to be bonded to another to form the multi-layer substrate construction.

Preferably, when the composition is applied on a multi-layer substrate construction, the composition is applied to an exterior surface of the multi-layer substrate construction, such that it is exposed, i.e. there is no layer, such as a protective layer or otherwise, overlying the composition.

It will be appreciated that the fifth aspect of the present invention encompasses multi-layer substrate constructions having a composition applied thereto, wherein the composition has just been applied and is molten, i.e. prior to it cooling to ambient temperature. The fifth aspect of the present invention also encompasses multi-layer substrate constructions having a composition applied thereto, wherein the composition is cool and solid at ambient temperature. This composition may be tacky or non-tacky.

A composition according to the first, second or third aspects of the present invention, a substrate to which the composition has been applied, or a multi-layer substrate construction to which the composition has been applied and/or incorporated within, may be suitable for end use as labels (adhesive or wraparound), and/or in fast-moving consumer goods; packaging such as disposable packaging including food and hot or cold beverage containers; hygiene and personal care product packaging such as shampoo bottles; cosmetic product packaging; decorative metal products; blister pack packaging; laminated pouches; medical and diagnostic devices and associated packaging.

The composition, substrate, and multi-layer substrate construction according to the present invention may find particular use in the packaging industry. The substrate or multi-layer substrate construction may be typically articles such as packaging products including, but not limited to paper-based and containers boxes including cardboard and cartonboard boxes and the like, paper-based tubes including cardboard tubes and the like, plastic bottles, paper-based bottles, plastic lids, glass bottles, aluminium cans and lids, steel cans and lids, wrap around labels, stretch sleeves, shrink sleeves, and self-adhesive labels.

According to a sixth aspect of the present invention, there is provided a method of forming a composition according to the first, second or third aspect of the present invention, the method comprising: heating the hot melt adhesive to a temperature at or above the melting temperature of the hot melt adhesive, but below the melting temperature or decomposition temperature of the colour-forming compound, and when present, the melting temperature of the thermal acid-generating agent, such that the hot melt adhesive becomes molten; and admixing the colour-forming compound and optionally, the thermal acid-generating agent and infrared radiation absorbing compound, in the molten hot melt adhesive such that it is distributed throughout the molten hot melt adhesive.

For the sixth aspect of the present invention, the composition may have any of the features described as preferred or optional with regard to any of the other aspects of the present invention.

For the formation of a composition, the hot melt adhesive is heated to or above its melting temperature such that it becomes molten (said melting temperature of the hot melt adhesive being lower than the melting or decomposition temperature of the colour-forming compound, and melting temperature of the thermal acid-generating agent where applicable) and the colour-forming compound is brought into contact, introduced and admixed into the molten hot melt adhesive.

Alternatively, the hot melt adhesive and colour-forming compound are brought into contact, heated to or above the melting temperature of the hot melt adhesive (said melting temperature of the hot melt adhesive being lower than the melting or decomposition temperature of the colour-forming compound, and melting temperature of the thermal acid-generating agent where applicable), and the colour-forming compound then admixed into the molten hot melt adhesive. It will further be appreciated that when the colour-forming compound is a leuco dye, and the composition further comprises a thermal acid-generating agent, and/or when an infrared radiation absorbing compound is present, the thermal acid-generating agent and/or infrared radiation absorbing compound is either introduced alongside the colour-forming compound into the hot melt adhesive in the molten state, or brought into contact with the hot melt adhesive and colour-forming compound prior to heating. In addition, when the colour-forming compound is a leuco dye, the leuco dye, and the thermal acid-generating agent may be separately brought into contact with a portion of hot melt adhesive, these portions then being combined, heated to or above the melting temperature of the hot melt adhesive (said melting temperature of the hot melt adhesive being lower than the melting temperatures of both the leuco dye and thermal acid-generating agent) and the leuco dye and thermal acid-generating agent present admixed into the hot melt adhesive in this molten state. This is also the case if an infrared radiation absorbing compound is utilised in the composition.

It will be appreciated that the colour-forming compound and if present, the thermal acid-generating agent or infrared radiation absorbing compound are introduced into the composition in solid particulate form.

In the method of formation of the composition of the first, second or third aspects of the present invention, the hot melt adhesive is heated to or above its melting temperature such that the hot melt adhesive becomes molten and able to flow.

The melting temperature of the hot melt adhesive is as discussed above for the composition of the first, second and third aspects of the present invention. Preferably, the hot melt adhesive is heated to from 50 to 200° C., or from 50 to 160° C., such as from 70 to 150° C.

As discussed above, during the formation of the composition according to the first, second or third aspect of the present invention, the melting or decomposition temperature of the colour-forming compound, and the melting temperature of the thermal acid-generating agent, as applicable, is not reached. The melting or decomposition temperature of the colour-forming compound, and melting temperature of the thermal acid-generating agent where applicable, are as described above in relation to the composition according to the first, second or third aspects of the present invention.

The heating of the hot melt adhesive in the formation of the composition of the present invention may be achieved by any means. Suitable heating apparatus include hot melt guns and applicators, extrusion and moulding equipment, injection, blow moulding, calendaring, rotational moulding, thermoforming and hot-melt coaters. Manufacture of the composition can be achieved using standard thermoplastic processing machinery, for example, equipment such as that used for extruding, blending, mixing, pulverising and moulding including injection and blow moulding and other typical equipment of different sizes and specifications can be used for calendaring, rotational moulding, thermoforming and hot-melt coating. This can include processing using liquid or solid masterbatches and in solid forms such as sticks, blocks, lumps, rods, balls, beads, pellets, granules and powders.

It will be appreciated by a skilled person that once the composition has been formed and when the hot melt adhesive is molten, the composition can be directly applied to a substrate or multi-layer substrate construction, or used in the formation of a multi-layer substrate construction as discussed above. The composition will then cool to ambient temperature and solidify on the substrate or multi-layer substrate construction, or during formation of the multi-layer substrate construction as the hot melt adhesive cools, and transitioning back to a solid state.

Alternatively, once the composition has been formed, the composition can be allowed to cool to ambient temperature and solidify such that the hot melt adhesive transitions back to the solid state. The composition as a whole is then in a solid state. The composition can then be stored or transported in the solid state, and when needed, re-heated to the melting temperature of the hot melt adhesive (selected so as to be below the melting temperature or decomposition temperature of the colour-forming compound, and where applicable, the melting temperature of the thermal acid-generating agent) in order that the hot melt adhesive becomes molten and the composition may be applied to a substrate or multi-layer substrate construction, or used in the formation of a multi-layer substrate construction.

According to a seventh aspect of the present invention, there is provided a method of forming a substrate comprising a composition according to the first, second or third aspect of the present invention applied thereon, wherein the method comprises: heating of the composition to a temperature at or above the melting temperature of the hot melt adhesive, but below the melting temperature or decomposition temperature of the colour-forming compound, and when present, the melting temperature of the thermal acid-generating agent or infrared radiation absorbing compound such that the hot melt adhesive becomes molten; applying the composition to the substrate when the hot melt adhesive is molten; and allowing the composition to cool and solidify on the substrate.

According to a eighth aspect of the present invention, there is provided a method of forming a multi-layer substrate construction comprising a composition according to the first, second or third aspect of the present invention applied thereon, wherein the method comprises: heating of the composition to a temperature at or above the melting temperature of the hot melt adhesive, but below the melting temperature or decomposition temperature of the colour-forming compound, and when present, the melting temperature of the thermal acid-generating agent or infrared radiation absorbing compound such that the hot melt adhesive becomes molten; applying the composition to the substrate when the hot melt adhesive is molten; and allowing the composition to cool and solidify.

According to a ninth aspect of the present invention, there is provided a method of forming a multi-layer substrate construction having a composition according to the first, second or third aspect of the present invention incorporated therein, wherein the method comprises: heating of the composition to a temperature at or above the melting temperature of the hot melt adhesive, but below the melting temperature or decomposition temperature of the colour-forming compound, and when present, the melting temperature of the thermal acid-generating agent or infrared radiation absorbing compound such that the hot melt adhesive becomes molten; applying the composition to the substrate when the hot melt adhesive is molten; and bringing the substrate into contact with another substrate with the composition positioned therebetween such that the substrate are bonded together by the composition to form a multi-layer substrate construction.

For the seventh to ninth aspects of the present invention, the composition, substrate or multi-layer substrate construction may have any of the features described as preferred or optional with regard to any of the other aspects of the present invention.

It will be appreciated that the composition is formed according to the method of the fifth aspect of the present invention described herein.

As discussed above, the composition may be applied to all, substantially all, or part of the surface area of an exterior surface of the substrate or multi-layer substrate construction, or one of the substrate s of the multi-layer substrate construction during formation thereof.

As discussed above, the composition may be applied to the substrate or multi-layer substrate construction, or substrate of the multi-layer substrate construction during the formation thereof using any appropriate application method. Suitable application methods include, but are not limited to: hot melt guns and applicators, extrusion, injection moulding, and moulding equipment and coaters.

As discussed above, the composition may be applied to the substrate or multi-layer substrate construction, or substrate of the multi-layer substrate construction during formation thereof, as a single layer or as multiple layers, i.e. once or multiple times. Preferably, the composition is applied to the substrate or multi-layer substrate construction as a single layer.

It will be appreciated that for the methods of forming the substrate or multi-layer substrate construction of the present invention having the composition of the present invention applied thereon, the composition is applied to the substrate or multi-layer substrate construction when molten and allowed to cool to ambient temperature and solidify. By allowing the composition to cool to ambient temperature and solidify following application to the substrate or multi-layer substrate construction, the hot melt adhesive of the composition transitions to a solid state. When the hot melt adhesive used is non-tacky at ambient temperature, it will be appreciated that as a result of this cooling, the composition solidifies and becomes resistant to removal during any subsequent handling, storage or use of the substrate or multi-layer substrate construction. .

Typically, the time taken for the composition to cool and solidify depends on the volume of the composition applied, i.e. the coat weight, but typically this is from 0.1 to 100 seconds, such as from 1 to 10 seconds at ambient temperature.

The composition may be applied to the substrate or multi-layer substrate construction, or substrate of the multi-layer substrate construction to any suitable coat weight, dependent upon the substrate to which the composition is applied, and application method. It will be appreciated by a skilled person that the coat weight of the composition on the substrate will affect the intensity of the colour of formed by the colour-forming compound. Preferably, the composition is applied to a coat weight of from 0.1 to 1000 gsm (grams per square metre), such as from 0.1 to 500 gsm, or 0.1 to 250 gsm, and most preferably from 0.1 to 150 gsm. This coat weight is per individual layer of the composition that is applied to the substrate or multi-layered substrate construction or substrate of the multi-layer substrate construction.

The coat weight of the composition may be measured by any suitable method. Suitable measuring methods will be well known to those skilled in the art.

Preferably, the coat weight is measured by weighing the same area of substrate with and without the composition applied thereto, and comparing the two weights.

It will be appreciated by a skilled person that in order for the application of the composition to the substrate, multi-layer substrate construction, or substrate of the multi-layer substrate construction to take place when the hot melt adhesive is molten, the composition must have been heated to or above the melting temperature of the hot melt adhesive (but below the melting temperature or decomposition temperature of the colour-forming compound, and melting temperature of the thermal acid-generating agent when present). This may be directly following production of the composition whilst the hot melt adhesive is molten, or following storage of the composition such that the composition is heated to or above the melting temperature of the hot melt adhesive therein (but below the melting temperature or decomposition temperature of the colour-forming compound, and melting temperature of the thermal acid-generating agent when present) in order that the hot melt adhesive becomes molten for application to the substrate. Suitable methods for heating the composition will be well known to a skilled person, and include typical industrial thermoplastic processing and application equipment such as that used for extruding, moulding, injection, blow moulding, calendaring, rotational moulding, thermoforming, hot-melt coating, glue guns and hot glue applicators. It will be appreciated that as the composition is not heated to the melting temperature or decomposition temperature of the colour-forming compound, and melting temperature of the thermal acid-generating agent when present, colour and/or image formation may be facilitated by the subsequent application of radiation.

It will be appreciated that for the methods of the seventh and eighth aspects of the present invention, following application to the substrate or multi-layer substrate construction, the colour-forming compound preferably does not display colour.

It will be appreciated that for the method of the ninth aspect of the present invention, the substrates may be brought together when the composition is molten and then cooled such that the composition bonds the substrates together. Alternatively, when the hot melt adhesive, and thus the composition, is tacky at ambient temperature, the substrates may be brought together when the composition is cool and solid, but tacky, at ambient temperature. Typically, the substrates, or at least one substrate, of the multi-layer substrate construction are transparent or translucent, such as polymeric films, such that upon application of radiation, any colour and/or image formed is visible and human and/or machine-readable. It will be appreciated that the multi-layer construction may comprise further substrates bonded to the at least two substrate discussed above, said further substrate being bonded by the same or typically, other adhesives not containing colour-forming compounds. Other adhesives will be well known to a skilled person.

It will be appreciated that for the methods of the ninth aspect of the present invention, following incorporation into multi-layer substrate construction, the colour-forming compound preferably does not display colour.

For the methods of forming the substrate and multi-layer substrate construction of the present invention having the composition of the present invention applied thereon, or the method of forming the multi-layer substrate construction of the present invention having the composition of the present invention incorporated therein, the melting temperature of the hot melt adhesive of the composition and the melting temperature or decomposition temperature of the colour-forming compound, and thermal acid-generating agent when present, are as described above for the present invention.

The composition of the present invention enables colour or an image to be formed. This is upon specific application of radiation.

According to a tenth aspect of the present invention, there is provided a method of forming colour and/or an image on a substrate comprising a composition according to the first, second or third aspect of the present invention applied thereon, wherein the method comprises applying radiation to the composition as required to form colour and/or an image on the substrate.

According to an eleventh aspect of the present invention, there is provided a method of forming colour and/or an image on and/or within a multi-layer substrate construction comprising a composition according to the first, second or third aspect of the present invention applied thereon and/or incorporated therein, wherein the method comprises applying radiation to the composition as required to form colour and/or an image on and/or within the multi-layer substrate construction.

The radiation may be applied to the composition at localised positions of the composition to selectively form colour and/or an image. A human and/or machine readable image is formed. It will be appreciated that in the context of the present invention, the colour or image is formed as upon application of radiation to the composition, the melting or decomposition temperature of the colour-forming compound, and melting temperature of the thermal acid-generating agent, as applicable, have been reached.

As discussed above, it will be appreciated that in the context of the present invention, the colour, or the colour of the image, formed upon application of radiation to the composition of the present invention is different to the colour that the composition of the present invention may have upon formulation, storage, or application to and/or incorporation within a substrate or multi-layer substrate construction prior to the application of radiation thereto. The colour and/or colour of the image formed upon application of radiation to the composition is different to, or has a stronger density than, the colour that those part(s) of the composition to which radiation is not applied may have. The colour-forming compound preferably only displays colour in the part(s) of the composition to which radiation is applied.

It will be appreciated by a skilled person that the radiation selected will be that required to cause the colour-forming compound to form a discernible colour. By “applied to the composition” in relation to a multi-layer substrate construction having the composition therein, refers to the application of the radiation to the area of the multi-layer substrate construction under which the composition is situated, and thus application of radiation to the composition is achieved.

For the tenth and eleventh aspects of the present invention, the composition, substrate or multi-layer substrate construction may have any of the features described as preferred or optional with regard to the any of the other aspects of the present invention.

The term “image” incorporates, but is not limited to: logos, marks such as words or text, graphics, figures, pictures, symbols, codes such as linear barcodes, 2D Datamatrix, QR codes, Digimarc codes and text, such as that based on alphanumerics and symbols. It will be appreciated that in the context of the present invention, it is the manipulation of the composition comprising the colour-forming compound as an image-forming compound that facilitates the formation of an image. The image formed will be human and/or machine readable, and can be used for coding and marking, tagging, tracking and tracing and late-stage customisation or personalisation purposes. The image formed is typically an image used to display variable information. The density of the image is measured by ODB, ODY, ODM, or ODC values and AODB, ΔODY, ΔODM, or ΔODC values as described above.

In the context of the present invention, the radiation is applied to the composition after it has cooled and solidified at ambient temperature, typically with the composition applied on the substrate, or applied on and/or incorporated within a multi-layer substrate construction.

“Radiation” and like terms used herein refers to energy in the form of waves or particles, and in particular, refers to electromagnetic radiation such as ultraviolet (UV), visible, and infrared (IR) including near-infrared (NIR) particle radiation, e.g. alpha (α) radiation, beta (β) radiation, neutron radiation and plasma. The wavelength ranges of the different regions of the electromagnetic spectrum are known to a skilled person.

It will be appreciated by a skilled person that the radiation applied to the composition depends upon the colour-forming compound admixed therein. The radiation may be selected from ultraviolet (UV) radiation with a wavelength of from 10 to 400 nm, visible radiation with a wavelength of from 400 to 700 nm, infrared (IR) radiation with a wavelength of from 700 nm to 1 mm, including near-infrared (NIR) radiation with a wavelength of from 700 to 1600 nm.

Preferably, the radiation is selected from infrared (IR) radiation with a wavelength of 9000 to 12000 nm (applied using a CO₂ laser), infrared radiation with a wavelength of from 700 nm to 1 mm, and near-infrared (NIR) radiation with a wavelength of 700 to 1600 nm. More preferably, the radiation is selected from infrared (IR) radiation with a wavelength of 9000 to 12000 nm (applied using a CO₂ laser) such as 9300, 9600, 10200 or 10600 nm (applied using a CO₂ laser), or even 10600 nm (applied using a CO₂ laser).

The radiation may be applied to the composition by any suitable means. Suitable means include by laser excitation through application of radiation to the composition by a laser source(s). Preferably, the radiation is applied to the composition from a laser source(s). It will be understood by a skilled person that the radiation may be applied to the composition at localised positions to selectively facilitate the formation of colour, and thus an image at these localised positions in the composition. These localised positions may overlap with each other. It will also be understood by a skilled person that the radiation is applied to the composition for an appropriate amount of time required to facilitate the formation of image. Typically the time required to deliver sufficient radiation will depend upon the means used to apply radiation and the method of application. For example, in one embodiment, the radiation may be applied to the composition for less than 120 seconds or for less than 60 seconds, such as for less than 20 seconds, or even less than 10 or 5 seconds.

It will be appreciated that when applied using a laser source(s), the radiation dosage applied can be controlled by alteration of the time for which the radiation is applied, the power of the means used to apply the radiation (wattage) and thus, the fluence (amount of energy delivered per unit area) delivered by a laser source(s), e.g. J/cm². It will be appreciated by a skilled person that this may affect the density of the image formed. For example, where a laser source(s) is used to apply the radiation, the fluence (amount of energy delivered per unit area) may affect the density of the image formed. In the context of the present invention, the fluence is dependent upon the power of the means used to apply the radiation (wattage), and the time for which the radiation is applied to a particular localised position on the substrate, which may be controlled by the scanning speed of the laser or the speed of the moving stage. These two variables can be altered to change the fluence. Where the fluence is low (e.g. lower power and/or shorter irradiation times), the image formed will have lower optical density, and where the fluence is high (e.g. higher power and/or longer irradiation times), the image formed will have a higher optical density and be of higher contrast with the background of the composition. In the context of the present invention, fluence values may range from 0.01 to 50 J/cm², such as from 0.1 to 25 J/cm², and even from 0.5 to 10 J/cm².

Preferably, the radiation is applied to the composition at localised positions of the composition in order to form a desired image. Essentially, upon application of the radiation, a colour is formed at the areas of the composition on the substrate to which the radiation is applied. The colour-forming compound undergoes a reaction to form colour. A human and/or machine readable image is thus generated. It is the colour-forming compound functioning as the ‘image-forming compound’ of the composition that enables an image to be formed.

According to a twelfth aspect of the present invention, there is provided a use of a composition according to the first, second or third aspect of the present invention in the formation of colour and/or an image.

According to a thirteenth aspect of the present invention, there is provided a use of a composition according to the first, second or third aspect of the present invention in the formation of colour and/or an image on a substrate having said composition applied thereon.

According to a fourteenth aspect of the present invention, there is provided a use of a composition according to the first, second or third aspect of the present invention in the formation of colour and/or an image on and/or within a multi-layer substrate construction having said composition applied thereon and/or incorporated therein.

For the twelfth to fourteenth aspects of the present invention, the composition, substrate or multi-layer substrate construction may have any of the features described as preferred or optional with regard to any of the other aspects of the present invention.

All of the features contained herein may be combined with any of the above aspects and in any combination.

All references to “%” refer to the weight percentage of the component in terms of the total composition or the hot melt adhesive, as indicated.

For a better understanding of the present invention, and to show how embodiments of the same may be carried into effect, reference will now be made, by way of example, to the following experimental data.

### EXAMPLES

### Example 1

0.8 grams of an oxyanion of a multivalent metal (ammonium octamolybdate (AOM)) and 0.8 grams of hot melt adhesive (obtained from a 7 mm hot melt adhesive glue stick from HobbyCraft (product code: 6217411000)) were heated to 140° C. (above the melting temperature of the hot melt adhesive, but below the decomposition temperature of AOM) in an aluminium foil tray using a hot plate.

The hot melt adhesive became molten and the AOM was admixed therethrough. The composition was left to cool to ambient temperature and solidify. No colour formation by the AOM was displayed. IR radiation was applied to part(s) of the composition using a Videojet VJ-3320 (10.6 μm) CO₂ laser such that the AOM formed colour and a black image was formed, as shown in FIG. 1.

### Example 2

0.8 grams of an oxyanion of a multivalent metal (ammonium octamolybdate (AOM)), 0.4 grams of an infrared or near-infrared radiation absorbing agent (copper (II) hydroxyl phosphate (CHP)) and 1.2 grams of hot melt adhesive (obtained from a 7 mm hot melt adhesive glue stick from HobbyCraft (product code: 6217411000)) were heated to 140° C. (above the melting temperature of the hot melt adhesive, but below the decomposition temperature of AOM) in an aluminium foil tray using a hot plate. The hot melt adhesive became molten and the AOM was admixed therethrough. The composition was left to cool to ambient temperature and solidify. No colour formation by the AOM was displayed, as shown in FIG. 2A. NIR radiation was applied to part(s) of the composition using a DataLase FL20 (1070 nm) NIR laser such that the AOM formed colour and a black image was formed, as shown in FIG. 2B. The optical density was altered by varying the fluence provided by the laser.

### Example 3

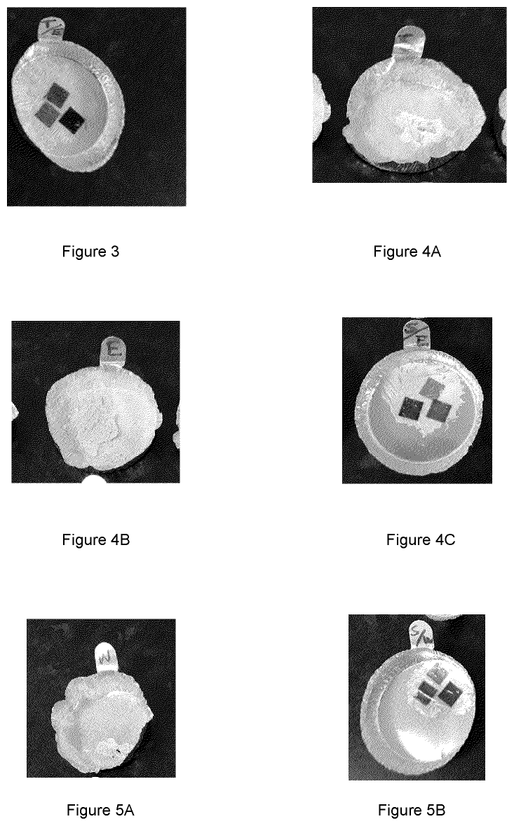

0.5 grams of a thermal acid-generating agent (THPE), 0.25 grams of a leuco dye (ETAC) and 0.75 grams of hot melt adhesive (obtained from a 7 mm hot melt adhesive glue stick from HobbyCraft (product code: 6217411000)) were heated to 140° C. (above the melting temperature of the hot melt adhesive, but below the melting temperature of both of the leuco dye and thermal acid-generating agent) in an aluminium foil tray using a hot plate. The hot melt adhesive became molten and the leuco dye and thermal acid-generating agent were admixed therethrough. The composition was left to cool to ambient temperature and solidify. No colour formation by the leuco dye was displayed. IR radiation was applied to part(s) of the composition using a Videojet VJ-3320 CO₂ laser such that the leuco dye formed colour and a black image was formed, as shown in FIG. 3. The optical density was altered by varying the fluence provided by the laser.

### Example 4

### Formulation 1

0.5 grams of a thermal acid-generating agent (N,N-dibutylbutan-1-aminium bis[2-(hydroxyl-kO)benzoate(2-)-kO]borate(1-)) and 1.0 grams of hot melt adhesive (obtained from a 7mm hot melt adhesive glue stick from HobbyCraft (product code: 6217411000)) were heated to 140 ° C. in an aluminium foil tray using a hot plate. The hot melt adhesive became molten and the thermal acid-generating agent was admixed therethrough. No colour formation was displayed, as shown in FIG. 4A.

### Formulation 2

0.5 grams of a leuco dye (ETAC) and 1.0 grams of hot melt adhesive (obtained from a 7mm hot melt adhesive glue stick from HobbyCraft (product code: 6217411000)) were heated to 140° C. in an aluminium foil tray using a hot plate. The hot melt adhesive became molten and the leuco dye was admixed therethrough. No colour formation was displayed, as shown in FIG. 4B.

0.1 grams of Formulation 1 and 0.1 grams of Formulation 2 were heated to 125° C. (above the melting temperature of the hot melt adhesive, but below the melting temperature of both of the leuco dye and thermal acid-generating agent) in an aluminium foil tray using a hot plate. The hot melt adhesive became molten and the leuco dye and thermal acid-generating agent were admixed therethrough. The composition was left to cool to ambient temperature and solidify. No colour formation by the leuco dye was displayed. IR radiation was applied to part(s) of the composition using a Videojet VJ-3320 CO₂ laser such that the leuco dye formed colour and a black image was formed, as shown in FIG. 4C. The optical density was altered by varying the fluence provided by the laser.

### Example 5

### Formulation 3

0.5 grams of a leuco dye (ODB-2: Wincon-2) and 1.0 grams of hot melt adhesive (obtained from a 7mm hot melt adhesive glue stick from HobbyCraft (product code: 6217411000)) were heated to 140° C. in an aluminium foil tray using a hot plate. The hot melt adhesive became molten and the leuco dye was admixed therethrough. No colour formation was displayed, as shown in FIG. 5A.

0.1 grams of Formulation 1 and 0.1 grams of Formulation 3 were heated to 125° C. (above the melting temperature of the hot melt adhesive, but below the melting temperature of both of the leuco dye and thermal acid-generating agent) in an aluminium foil tray using a hot plate. The hot melt adhesive became molten and the leuco dye and thermal acid-generating agent were admixed therethrough. The composition was left to cool to ambient temperature and solidify. No colour formation by the leuco dye was displayed. IR radiation was applied to part(s) of the composition using a Videojet VJ-3320 CO₂ laser such that the leuco dye formed colour and a black image was formed, as shown in FIG. 5B. The optical density was altered by varying the fluence provided by the laser.

### Example 6

### Formulation 4

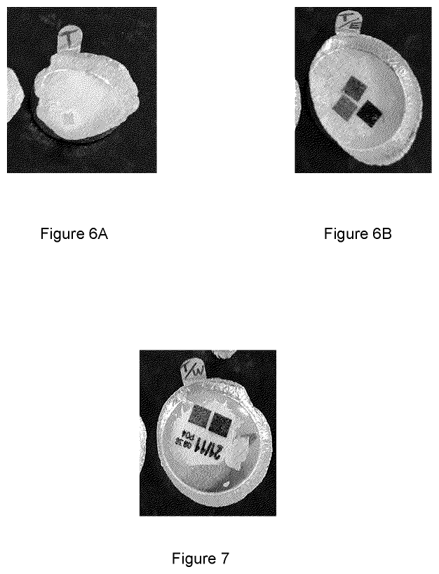

0.5 grams of a thermal acid-generating agent (THPE) and 1.0 grams of hot melt adhesive (obtained from a 7mm hot melt adhesive glue stick from HobbyCraft (product code: 6217411000)) were heated to 140° C. in an aluminium foil tray using a hot plate. The hot melt adhesive became molten and the thermal acid-generating agent was admixed therethrough. No colour formation was displayed, as shown in FIG. 6A.

0.1 grams of Formulation 4 and 0.1 grams of Formulation 2 were heated to 140° C. (above the melting temperature of the hot melt adhesive, but below the melting temperature of both of the leuco dye and thermal acid-generating agent) in an aluminium foil tray using a hot plate. The hot melt adhesive became molten and the leuco dye and thermal acid-generating agent were admixed therethrough. The composition was left to cool to ambient temperature and solidify. No colour formation by the leuco dye was displayed. IR radiation was applied to part(s) of the composition using a Videojet VJ-3320 CO₂ laser such that the leuco dye formed colour and a black image was formed, as shown in FIG. 6B. The optical density was altered by varying the fluence provided by the laser.

### Example 7

0.1 grams of Formulation 4 and 0.1 grams of Formulation 3 were heated to 140° C. (above the melting temperature of the hot melt adhesive, but below the melting temperature of both of the leuco dye and thermal acid-generating agent) in an aluminium foil tray using a hot plate. The hot melt adhesive became molten and the leuco dye and thermal acid-generating agent were admixed therethrough. The composition was left to cool to ambient temperature and solidify. No colour formation by the leuco dye was displayed. IR radiation was applied to part(s) of the composition using a Videojet VJ-3320 CO₂ laser such that the leuco dye formed colour and a black image was formed, as shown in FIG. 7. The optical density was altered by varying the fluence provided by the laser.

### Example 8

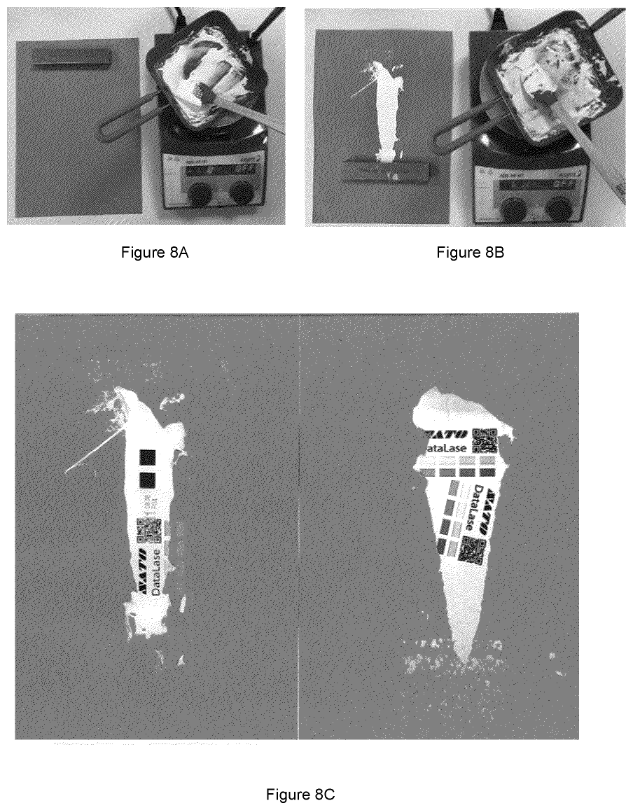

4.0 grams of an oxyanion of a multivalent metal (ammonium octamolybdate (AOM)) and 4.0 grams of hot melt adhesive (obtained from a 7 mm hot melt adhesive glue stick from HobbyCraft (product code: 6217411000)) were heated to 140° C. (above the melting temperature of the hot melt adhesive, but below the decomposition temperature of AOM) in a pan using a hot plate. The hot melt adhesive became molten and the AOM was admixed therethrough. No colour formation by the AOM was displayed, as shown in FIG. 8A.

The composition was applied to a brown box paper liner using a 25 μm gap size ‘bird bar’ applicator whilst the hot melt adhesive, and thus the composition, was molten. The composition was left to cool to ambient temperature on the substrate and solidify. No colour formation by the AOM was displayed, as shown in FIG. 8B. IR radiation was applied to part(s) of the composition using a Videojet VJ-3320 CO₂ laser such that the AOM formed colour and a black image was formed, as shown in FIG. 8C. The optical density was altered by varying the fluence provided by the laser.

### Example 9

2.5 grams of a thermal acid-generating agent (THPE), 1.5 grams of a leuco dye (ETAC) and 4.0 grams of hot melt adhesive (obtained from a 7 mm hot melt adhesive glue stick from HobbyCraft (product code: 6217411000)) were heated to 140° C. (above the melting temperature of the hot melt adhesive, but below the melting temperature of both of the leuco dye and thermal acid-generating agent) in a pan using a hot plate. The hot melt adhesive became molten and the leuco dye and thermal acid-generating agent were admixed therethrough. No colour formation by the leuco dye was displayed.

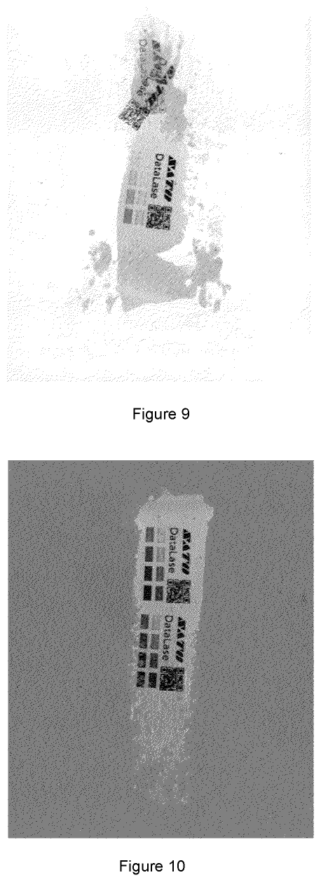

The composition was applied to white cartonboard using a 25 μm gap size ‘bird bar’ applicator whilst the hot melt adhesive, and thus the composition, was molten. The composition was left to cool to ambient temperature on the substrate and solidify. No colour formation by the leuco dye was displayed. IR radiation was applied to part(s) of the composition using a Videojet VJ-3320 CO₂ laser such that the leuco dye formed colour and a black image was formed, as shown in FIG. 9. The optical density was altered by varying the fluence provided by the laser.

### Example 10

2.5 grams of a thermal acid-generating agent (N,N-dibutylbutan-1-aminium bis [2-(hydroxy-kO)benzoato(2-)-kO]borate(1-)), 1.5 grams of a leuco dye (ETAC) and 5 grams of hot melt adhesive (obtained from a 7mm hot melt adhesive glue stick from HobbyCraft (product code: 6217411000)) were heated to 125° C. (above the melting temperature of the hot melt adhesive, but below the melting temperature of both of the leuco dye and thermal acid-generating agent) in a pan using a hot plate. The hot melt adhesive became molten and the leuco dye and thermal acid-generating agent were admixed therethrough. No colour formation by the leuco dye was displayed.

The composition was applied to a brown box paper liner using a 25 μm gap size ‘bird bar’ applicator whilst the hot melt adhesive, and thus the composition, was molten. The composition was left to cool to ambient temperature on the substrate and solidify. No colour formation by the leuco dye was displayed. IR radiation was applied to part(s) of the composition using a Videojet VJ-3320 CO₂ laser such that the leuco dye formed colour and a black image was formed, as shown in FIG. 10. The optical density was altered by varying the fluence provided by the laser.

### Example 11

2.5 grams of a thermal acid-generating agent (THPE), 1.5 grams of a leuco dye (ETAC) and 4.0 grams of hot melt adhesive (obtained from a 7 mm hot melt adhesive glue stick from HobbyCraft (product code: 6217411000)) were heated to 140° C. (above the melting temperature of the hot melt adhesive, but below the melting temperature of both of the leuco dye or thermal acid-generating agent) in a pan using a hot plate. The hot melt adhesive became molten and the leuco dye and thermal acid-generating agent were admixed therethrough. No colour formation by the leuco dye was displayed.

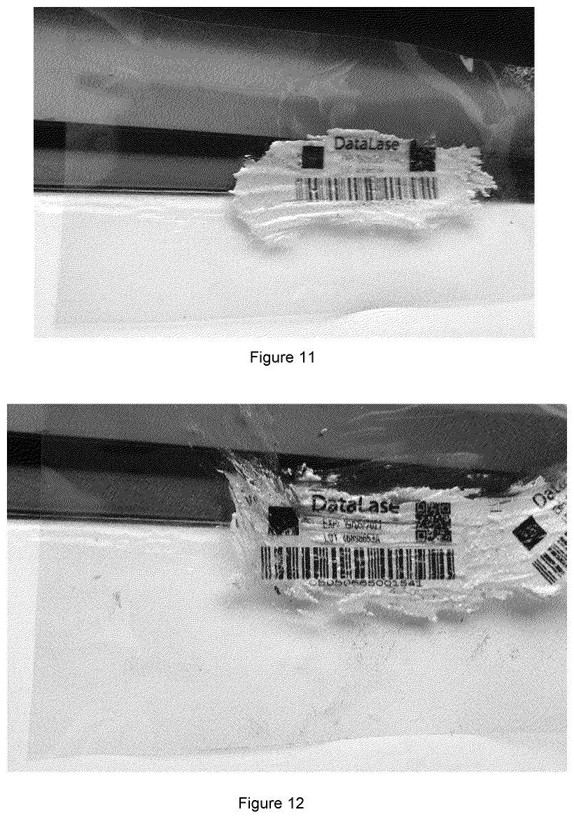

The composition was applied to a 96 μm PET (poly ethylene terephthalate) clear film from HiFi films using a 25 μm gap size ‘bird bar’ applicator whilst the hot melt adhesive, and thus the composition, was molten. The composition was left to cool to ambient temperature on the substrate and solidify. No colour formation by the leuco dye was displayed. IR radiation was applied to part(s) of the composition using a Videojet VJ-3320 CO₂ laser such that the leuco dye formed colour and a black image was formed, as shown in FIG. 11.

### Example 12

2.5 grams of a thermal acid-generating agent (N,N-dibutylbutan-1-aminium bis [2-(hydroxy-kO)benzoato(2-)-kO]borate(1-)), 1.5 grams of a leuco dye (ETAC) and 5 grams of hot melt adhesive (obtained from a 7mm hot melt adhesive glue stick from HobbyCraft (product code: 6217411000)) were heated to 125° C. (above the melting temperature of the hot melt adhesive, but below the melting temperature of both of the leuco dye and thermal acid-generating agent) in a pan using a hot plate. The hot melt adhesive became molten and the leuco dye and thermal acid-generating agent were admixed therethrough. No colour formation by the leuco dye was displayed.

The composition was applied to a 96 μm PET (poly ethylene terephthalate) clear film from HiFi films using a 25 μm gap size ‘bird bar’ applicator whilst the hot melt adhesive, and thus the composition, was molten. The composition was left to cool to ambient temperature on the substrate and solidify. No colour formation by the leuco dye was displayed. IR radiation was applied to part(s) of the composition using a Videojet VJ-3320 CO₂ laser such that the leuco dye formed colour and a black image was formed, as shown in FIG. 12.

### Example 13

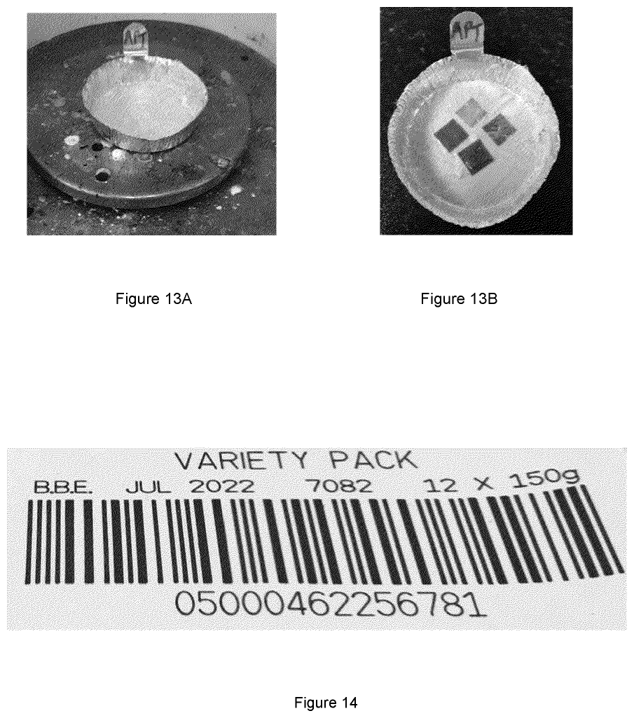

0.5 grams of an oxyanion of a multivalent metal or oxyacid or hydrate thereof (ammonium paratungstate (NH₄)₁₀(H₂W₁₂O₄₂).4H₂O) which was dried in an oven at 100° C. for 16 hours and ground in a mortar & pestle and 1.0 grams of hot melt adhesive (obtained from a 7mm hot melt adhesive glue stick from HobbyCraft (product code: 6217411000)) were heated to 140° C. (above the melting temperature of the hot melt adhesive, but below the decomposition temperature of the anhydrous ammonium salt of an oxyanion of a multivalent metal) in an aluminium foil tray using a hot plate. The hot melt adhesive became molten and the anhydrous ammonium salt of an oxyanion of a multivalent metal was admixed therethrough. The composition was left to cool to ambient temperature and solidify. No colour formation by the anhydrous ammonium salt of an oxyanion of a multivalent metal was displayed, as shown in FIG. 13A. IR radiation was applied to part(s) of the composition using a Videojet VJ-3320 (10.6 μm) CO₂ laser such that the anhydrous ammonium salt of an oxyanion of a multivalent metal formed colour and a black image was formed, as shown in FIG. 13B. The optical density was altered by varying the fluence provided by the laser.

### Example 14

20 wt % of an oxyanion of a multivalent metal or oxyacid or hydrate thereof (ammonium octamolybdate (AOM)) and 80 wt % of hot melt adhesive (obtained from Caswell Adhesives) were heated to above the melting temperature of the hot melt adhesive, but below the decomposition temperature of AOM. The hot melt adhesive became molten and the AOM was admixed therethrough. No colour formation by the AOM was displayed.

The composition was applied to a paper-based release-liner whilst the hot melt adhesive, and thus the composition, was molten. The composition was left to cool to ambient temperature on the substrate and solidify. No colour formation by the AOM was displayed. IR radiation was applied to part(s) of the composition using a Videojet VJ-3320 CO₂ laser (10.6 μm) such that the AOM formed colour and a black image was formed, as shown in FIGS. 14 to 17.

### Example 15

3.5 grams of an oxyanion of a multivalent metal or oxyacid or hydrate thereof (ammonium octamolybdate (AOM)) and 6.5 grams of hot melt adhesive (Formulation 5) were heated to 150° C. (above the melting temperature of the hot melt adhesive, but below the decomposition temperature of AOM). The hot melt adhesive became molten and the AOM was admixed therethrough. No colour formation by the AOM was displayed.

Formulation 5

| Component | Wt % |
|---|---|
| Ethylene-vinyl acetate copolymer (CAS no. 24937-78-8, Sigma | 30.5 |
| Aldrich poly(ethylene-co-vinyl acetate, MFI 19 g/10 min @ | |
| 190° C./2.16 kg, 25% vinyl acetate)* | |
| Gum Rosin (natural resin) (CAS no. 8050-09-7, Sigma Aldrich) | 34.5 |
| Paraffin wax (Sigma Aldrich) | 20 |
| Polyethylene (LDPE) (Sigma Aldrich) | 15 |

*contains BHT (butylated hydroxytoluene as inhibitor)

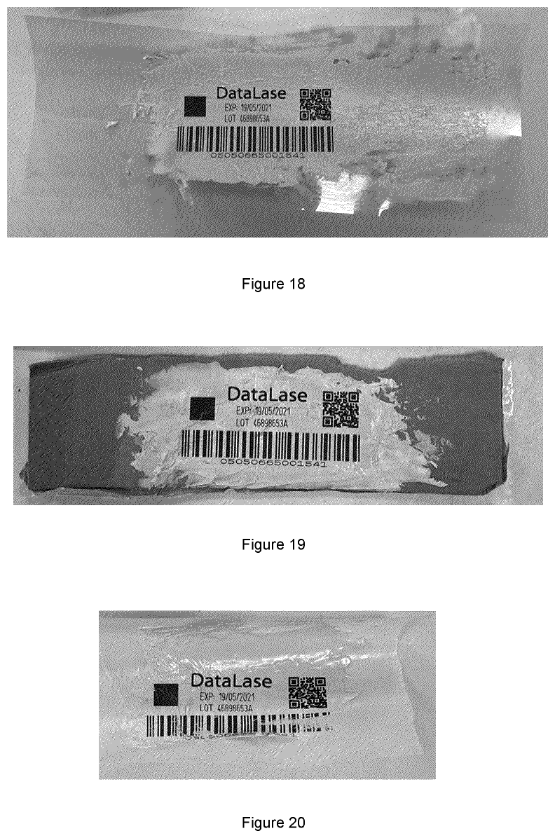

The composition was separately applied to a paper-based release-liner, a 96 μm PET (poly ethylene terephthalate) clear film from HiFi films, and cardboard, whilst the hot melt adhesive, and thus the composition, was molten. The composition was left to cool to ambient temperature on the substrates and solidify. No colour formation by the AOM was displayed. IR radiation was applied to part(s) of the composition using a Videojet VJ-3320 CO₂ laser 190 mm lens (10.6 μm) such that the AOM formed colour and a black image was formed, as shown in FIGS. 18 to 20.

### Comparative Examples

### Comparative Example 1

### Formulation 6

0.5 grams of a thermal acid-generating agent 4-Hydroxyphenyl-4′-isopropoxyphenyl sulfone (Chameleon Developer-1) and 1.0 grams of hot melt adhesive (obtained from a 7 mm hot melt adhesive glue stick from HobbyCraft) were heated to 140° C. in an aluminium foil tray using a hot plate. The hot melt adhesive became molten and the thermal acid-generating agent was admixed therethrough. No colour formation was displayed, as shown in FIG. 21A.

0.1 grams of Formulation 5 and 0.1 grams of Formulation 2 were heated to 140° C. (above the melting temperature of the hot melt adhesive, and above the melting temperature of one or both of the leuco dye and thermal acid-generating agent) in an aluminium foil tray using a hot plate. The hot melt adhesive became molten and the leuco dye and thermal acid-generating agent were admixed therethrough. A black colour was formed by the leuco dye, as shown in FIG. 21B. Subsequent application of radiation to form an image was therefore not possible.

### Comparative Example 2

0.1 grams of Formulation 5 and 0.1 grams of Formulation 3 were heated to 125° C. (above the melting temperature of the hot melt adhesive, and above the melting temperature of one or both of the leuco dye and thermal acid-generating agent) in an aluminium foil tray using a hot plate. The hot melt adhesive became molten and the leuco dye and thermal acid-generating agent were admixed therethrough. A black colour was formed by the leuco dye, as shown in FIG. 22. Subsequent application of radiation to form an image was therefore not possible.

### Comparative Example 3

0.75 grams of a thermal acid-generating agent 4-Hydroxyphenyl-4′-isopropoxyphenyl sulfone (Chameleon Developer-1), 0.75 grams of leuco dye 3-di-n-butylamino-6-methyl-7-phenylaminofluoran (ODB-2: Wincon-2) and 1.5 grams of hot melt adhesive (obtained from a 7 mm hot melt adhesive glue stick from HobbyCraft) were heated to 125° C. (above the melting temperature of the hot melt adhesive, and above the melting temperature of one or both of the leuco dye and thermal acid-generating agent) in an aluminium foil tray using a hot plate. The hot melt adhesive became molten and the leuco dye and thermal acid-generating agent were admixed therethrough. A black colour was formed by the leuco dye, as shown in FIG. 23. Subsequent application of radiation to form an image was therefore not possible.

1. A composition formed of a hot melt adhesive having a colour-forming compound admixed therein, wherein the colour-forming compound is selected from a leuco dye and an oxyanion of a multivalent metal or an oxyacid or hydrate thereof, and wherein when the colour-forming compound is a leuco dye:
(a) the leuco dye is selected from 2′-Anilino-6′-(dibutylamino)-3′-methyl-3H-spiro[2-benzofuran-1,9′-xanthen]-3-one and 2-Anilino-6′-[ethyl(p-toyl)amino]-3′-methylspiro[5isobenzofuran-1 (3H),9′-[9H]xanthene]-3-one;
(b) the hot melt adhesive further has a thermal acid-generating agent admixed therein, the thermal acid-generating agent being selected from 1,1,1-Tris(4-Hydroxyphenyl)Ethane (THPE), tri-n-butylammonium-4,4′-dioxo-4H,4′H-2,2′-spirobi[benzo[d][1,3,2]dioxaborinin]-2-uide, N,N-dibutylbutan-1-aminium bis[2-(hydroxy-kO)benzoato(2-)-kO]borate(1-), 4-hydroxy-4′-isopropoxydiphenylsulfone, (2,4-dihydroxyphenyl)phenylmethanone, 3-(3-tosylureido)phenyl-4-methylbenzenesulfonate, propyl-3,4,5-trihydroxybenzoate and 4,4′-methanediyldiphenol, and
(c) the melting temperature of the hot melt adhesive is lower than the melting temperature of both of the leuco dye and thermal acid-generating agent; and
when the colour-forming compound is an oxyanion of multivalent metal or an oxyacid or hydrate thereof, the melting temperature of the hot melt adhesive is lower than the decomposition temperature of the oxyanion of a multivalent metal or an oxyacid or hydrate thereof.

2. A composition formed of a hot melt adhesive having a colour-forming compound and an infrared radiation absorbing compound admixed therein, wherein the colour-forming compound is selected from a leuco dye or an oxyanion of a multivalent metal or an oxyacid or hydrate thereof, and wherein:
when the colour-forming compound is a leuco dye, the hot melt adhesive further has a thermal acid-generating agent admixed therein and the melting temperature of the hot melt adhesive is lower than the melting temperature of both of the leuco dye and thermal acid-generating agent; and when the colour-forming compound is an oxyanion of a multivalent metal or an oxyacid or hydrate thereof, the melting temperature of the hot melt adhesive is lower than the decomposition temperature of the oxyanion of a multivalent metal or an oxyacid or hydrate thereof.

3. The composition according to claim 1, wherein the colour-forming compound is selected from ammonium octamolybdate, and the following leuco dyes: 2′-Anilino-6′-(dibutylamino)-3′-methyl-3H-spiro[2-benzofuran-1,9′-xanthen]-3-one, and 2-Anilino-6′-[ethyl(p-toyl)amino]-3′-methylspiro[5isobenzofuran-1 (3H),9′-[9H]xanthene]-3-one, and wherein when the colour-forming compound is a leuco dye, the hot melt adhesive further has a thermal acid-generating agent, 1,1,1-Tris(4-Hydroxyphenyl)Ethane, admixed therein.

4. The composition according to claim 1, wherein the hot melt adhesive comprises a thermoplastic polymer, copolymer, oligomer, or mixture thereof, selected from poly(ethylene-vinyl acetate) or ethylene-vinyl acetate copolymers;
poly(ethylene acrylate) copolymers; acrylics; polyvinyl butyral; polyolefins such as polybutene, polyethylene, and polypropylene, including both low-density (LDPE) and high-density (HDPE) polyethylene; polyamides such as ethylene diamine and hexamethylene diamine; nylon; polyesters including poly(lactic acid) (PLA), polyethylene terephthlate (PET), polyhydroxyalkanoates (PHA), and poly(glycolic acid) (PGA); polyurethanes; acrylic and styrene-acrylate copolymers; styrene-isoprene-styrene block tri- and copolymers; polystyrenes (PS); polycaprolactones; polycarbonates; fluoropolymers; elastomers; silicone rubbers and polypyrrole, or combinations thereof,
preferably wherein the thermoplastic polymer, copolymer, oligomer, or mixture thereof, is selected from polyethylene terephthalate (PET), polyhydroxyalkanoates (PHA), poly(glycolic acid) (PGA), poly(ethylene-vinyl acetate) or ethylene-vinyl acetate copolymer, low density polyethylene (LDPE), high-density polyethylene, and poly(lactice acid) (PLA), preferably, the thermoplastic polymer, copolymer, oligomer, or mixture thereof, is selected from polyhydroxyalkanoates (PHA), poly(glycolic acid) (PGA), poly(ethylene-vinyl)acetate) or ethylene-vinyl acetate copolymer, and low-density polyethylene (LDPE), more preferably, the thermoplastic polymer, copolymer, oligomer or mixture thereof, is selected from a polyhydroxyalkanoates (PHA), poly(glycolic acid) (PGA), and a poly(ethylene-vinyl acetate) or ethylene-vinyl acetate copolymer and more preferably, the thermoplastic polymer, copolymer, oligomer is a poly(ethylene-vinyl acetate) or ethylene-vinyl acetate copolymer, and
optionally wherein the thermoplastic polymer, copolymer, oligomer, or mixture thereof, is a bio-plastic or petro-plastic thermoplastic polymer, copolymer, oligomer, or mixture thereof, and/or wherein the thermoplastic polymer, copolymer, oligomer, or mixture thereof, is recyclable, biodegradable and/or compostable.

5-7. (canceled)

8. The composition according to claim 1, wherein the hot melt adhesive has a melt flow index of from 1 to 1000 g/10 mins, preferably from 100 to 1,000 g/10 mins, and more preferably from 500 to 900 g/10 mins, and
optionally wherein the hot melt adhesive has a melting point of from 50 to 200° C., or from 50 to 160° C. or from 70 to 150° C.

9. (canceled)

10. The composition according to claim 1, wherein when the colour-forming compound is a leuco dye, the thermal acid-generating agent is selected from 1,1,1-Tris(4-Hydroxyphenyl)Ethane, and, N,N-dibutylbutan-1-aminium bis[2-(hydroxy-kO)benzoato(2-)-kO]borate(1-), preferably 1,1,1-Tris(4-Hydroxyphenyl)Ethane.

11. The composition according to claim 1, wherein when the colour-forming compound is an oxyanion of a multivalent metal or oxyacid or hydrate thereof, the oxyanion of a multivalent metal or oxyacid or hydrate thereof is an oxyanion of a multivalent metal or hydrate of an oxyanion of a multivalent metal, preferably sodium molybdate dihydrate, or an ammonium salt of an oxyanion of a multivalent metal, preferably sodium molydbate dihydrate, or an ammonium salt of an oxyanion of molybdenum, preferably sodium molybdate dihydrate, or ammonium octamolybdate (AOM), and more preferably ammonium octamolybdate (AOM), and
preferably wherein the colour-forming compound is the oxyanion of a multivalent metal or oxyacid or hydrate thereof, preferably an oxyanion of a multivalent metal or hydrate of an oxyanion of a multivalent metal, preferably sodium molybdate dihydrate, or an ammonium salt of an oxyanion of a multivalent metal, preferably sodium molydbate dihydrate, or an ammonium salt of an oxyanion of molybdenum, preferably sodium molybdate dihydrate, or ammonium octamolybdate (AOM), and more preferably ammonium octamolybdate (AOM).

12-18. (canceled)

19. The composition according to claim 1, wherein the hot melt adhesive further has an infrared radiation absorbing compound admixed therein.

20. (canceled)

21. A substrate comprising a composition according to claim 1, applied thereon, preferably wherein the composition is on the exterior of the substrate or multi-layer substrate construction such that it is exposed, and optionally wherein the substrate or multi-layer substrate construction is a packaging article, preferably a packaging product including paper-based and containers boxes including cardboard and cartonboard boxes, paper-based tubes including cardboard tubes, plastic bottles, paper-based bottles, plastic lids, glass bottles, aluminium cans and lids, steel cans and lids, wrap around labels, stretch sleeves, shrink sleeves, and self-adhesive labels, and preferably wherein the hot melt adhesive of the composition is a bio-plastic thermoplastic polymer, copolymer, oligomer, or mixture thereof, and the substrate or multi-layer substrate construction is formed from a bio-plastic material.

22. A multi-layer substrate construction comprising a composition according to claim 1 applied thereon and/or incorporated therein, preferably wherein the composition is on the exterior of the substrate or multi-laver substrate construction such that it is exposed, and optionally wherein the substrate or multi-layer substrate construction is a packaging article, preferably a packaging product including paper-based and containers boxes including cardboard and cartonboard boxes, paper-based tubes including cardboard tubes, plastic bottles, paper-based bottles, plastic lids, glass bottles, aluminium cans and lids, steel cans and lids, wrap around labels, stretch sleeves, shrink sleeves, and self-adhesive labels and preferably wherein the hot melt adhesive of the composition is a bio-plastic thermoplastic polymer, copolymer, oligomer, or mixture thereof, and the substrate or multi-layer substrate construction is formed from a bio-plastic material.

23-37. (canceled)

38. A composition according to claim 2, wherein the colour-forming compound is selected from ammonium octamolybdate, and the following leuco dyes: 2′-Anilino-6′-(dibutylamino)-3′-methyl-3H-spiro[2-benzofuran-1,9′-xanthen]-3-one, and 2-Anilino-6′-[ethyl(p-toyl)amino]-3′-methylspiro[5isobenzofuran-1 (3H), 9′-[9H]xanthene]-3-one, and wherein when the colour-forming compound is a leuco dye, the hot melt adhesive further has a thermal acid-generating agent, 1,1,1-Tris(4-Hydroxyphenyl)Ethane, admixed therein.

39. The composition according to claim 2, wherein the hot melt adhesive comprises a thermoplastic polymer, copolymer, oligomer, or mixture thereof, selected from poly(ethylene-vinyl acetate) or ethylene-vinyl acetate copolymers; poly(ethylene acrylate) copolymers; acrylics; polyvinyl butyral; polyolefins such as polybutene, polyethylene, and polypropylene, including both low-density (LDPE) and high-density (HDPE) polyethylene;
polyamides such as ethylene diamine and hexamethylene diamine; nylon; polyesters including poly(lactic acid) (PLA), polyethylene terephthlate (PET), polyhydroxyalkanoates (PHA), and poly(glycolic acid) (PGA); polyurethanes; acrylic and styrene-acrylate copolymers; styrene-isoprene-styrene block tri- and copolymers; polystyrenes (PS); polycaprolactones; polycarbonates; fluoropolymers; elastomers; silicone rubbers and polypyrrole, or combinations thereof, preferably wherein the thermoplastic polymer, copolymer, oligomer, or mixture thereof, is selected from polyethylene terephthalate (PET), polyhydroxyalkanoates (PHA), poly(glycolic acid) (PGA), poly(ethylene-vinyl acetate) or ethylene-vinyl acetate copolymer, low density polyethylene (LDPE), high-density polyethylene, and poly(lactic acid) (PLA), preferably, the thermoplastic polymer, copolymer, oligomer, or mixture thereof, is selected from polyhydroxyalkanoates (PHA), poly(glycolic acid) (PGA), poly(ethylene-vinyl acetate) or ethylene-vinyl acetate copolymer, and low-density polyethylene (LDPE), more preferably, the thermoplastic polymer, copolymer, oligomer, or mixture thereof, is selected from a polyhydroxyalkanoates (PHA), poly(glycolic acid) (PGA), and a poly(ethylene-vinyl acetate) or ethylene-vinyl acetate copolymer, and more preferably, the thermoplastic polymer, copolymer, oligomer is a poly(ethylene-vinyl acetate) or ethylene-vinyl acetate copolymer, and optionally wherein the thermoplastic polymer, copolymer, oligomer, or mixture thereof, is a bio-plastic or petro-plastic thermoplastic polymer, copolymer, oligomer, or mixture thereof, and/or wherein the thermoplastic polymer, copolymer, oligomer, or mixture thereof, is recyclable, biodegradable and/or compostable.

40. The composition according to claim 2, wherein the hot melt adhesive has a melt flow index of from 1 to 1000 g/10 mins, preferably from 100 to 1,000 g/10 mins, and more preferably from 500 to 900 g/10 mins, and optionally wherein the hot melt adhesive has a melting point of from 50 to 200° C., or from 50 to 160° C., or from 70 to 150° C.

41. The composition according to claim 2, wherein when the colour-forming compound is a leuco dye, the leuco dye is selected from 3-di-n-butylamino-6-methyl-7-phenylaminofluoran (ODB-2: Wincon-2); 3-(N-ethyl-N-p-tolylamino)-6-methyl-7-anilinofluoran or 2-Anilino-6′-[ethyl(p-toyl)amino]-3′-methylspiro[isobenzofuran-1 (3H),9′-[9H]xanthene]-3-one (ETAC); 6-(Dimethylamino)-3,3-bis[4-(dimethylamino)phenyl]phthalide (Blue I2R-crystal violet lactone); and 3,3′-bis(1-n-octyl-2-methylindol-3-yl)phthalide (Red I6B), 2-Anilino-3-diethylamino-6-methylfluoran (Chameleon Black 1), 2-Anilino-6-dibutylamino-3-methylfluoran (Chameleon Black 2), 6-(Dimethylamino)-3,3-bis[4-(dimethylamino) phenyl]phthalide (Chameleon Blue 3), 4,4′-[(9-butyl-9H-carbazol-3-yl)methylene]bis[N-methyl-N-phenylaniline] (Chameleon Blue 4), 3,3′-Bis(1-n-octyl-2-methylindol-3-yl)phthalide (Chameleon Red 5), 6′-(Diethylamino)-3-oxo-spiro [isobenzofuran-1(3H),9′-[9H]xanthene]-2′-carboxylic acid ethyl ester (Chameleon Orange 6), 7-[4-(diethylamino)-2-ethoxyphenyl]-7-(2-methyl-1-octyl-1H-indol-3-yl) Furo[3,4-b]pyridin-5(7H)-one (Chameleon Blue 8), 2′-(Dibenzylamino)-6′-(diethylamino)fluoran (Chameleon Green 9), N,N-dimethyl-4-[2-[2-(octyloxy)phenyl]-6-phenyl-4-pyridinyl]-Benzenamine (Chameleon Yellow 10), 6′-(diethylamino)-2′-[(dimethylphenyl) amino]-3′-methylspiro[isobenzofuran-1(3H), 9′-[9H]xanthene]-3-one (Chameleon Black 15), 2′-Anilino-6′-(dibutylamino)-3′-methyl-3H-spiro[2-benzofuran-1,9′-xanthen]-3-one (CAS No. 89331-94-2) (ODB-2/Wincon-2), 6′-(Diethylamino)-3′-methyl-2′-(phenylamino)spiro[2-benzofuran-3,9′-xanthene]-1-one (CAS No. 29512-49-0) (OBD-1/Wincon-1), 2-Anilino-6′-[ethyl(p-toyl)amino]-3′-methylspiro[isobenzofuran-1 (3H),9′-[9H]xanthene]-3-one (CAS No. 59129-79-2), 6-(dimethylamino)-3,3-bis-[4-(dimethylamino) phenyl) phthalide (Blue3-CVL, CAS No 1522-42-7), 4,4′-[(9-butyl-9H-carbazol-3-yl)methylene]bis[N-methyl-N-phenylaniline] (Blue-4, CAS No 67707-04-4), 3,3′-Bis(1-n-octyl-2-methylindol-3-yl)phthalide (Red-5, CAS No 50292-95-0), 6′-(Diethylamino)-3-oxo-spiro [isobenzofuran-1(3H),9′-[9H]xanthene]-2′-carboxylic acid ethyl ester (Orange-6, CAS No 154306-60-2), 7-[4-(diethylamino)-2-ethoxyphenyl]-7-(2-methyl-1-octyl-1H-indol-3-yl) Furo[3,4-b]pyridin-5(7H)-one (Blue-8, CAS No 87563-89-1), 2′-(Dibenzylamino)-6′-(diethylamino)fluoran (Green-9, CAS No 34372-72-0), N,N-dimethyl-4-[2-[2-(octyloxy)phenyl]-6-phenyl-4-pyridinyl]-Benzenamine (Yellow-10, CAS No 144190-25-0), 6′-(diethylamino)-2′-[(dimethylphenyl) amino]-3′-methylspiro[isobenzofuran-1(3H),9′-[9H]xanthene]-3- one (Black-15, CAS No 36431-22-8), 2-Anilino-6-dibutylamino-3-methylfluoran, 6-(Dimethylamino)-3,3-bis[4-(dimethylamino)phenyl]phthalide, 4,4′-[(9-butyl-9H-carbazol-3-yl)methylene]bis[N-methyl-N-phenylaniline], 3,3′-Bis(1-n-octyl-2-methylindol-3-yl)phthalide, 6′-(Diethylamino)-3-oxo-spiro[isobenzofuran-1(3H), 9′-[9H]xanthene]-2′-carboxylic acid ethyl ester, 7-[4-(diethylamino)-2-ethoxyphenyl]-7-(2-methyl-1-octyl-1H-indol-3-yl) Furo[3,4-b]pyridin-5(7H)-one, 2′-(Dibenzylamino)-6′-(diethylamino)fluoran, N,N-dimethyl-4-[2-[2-(octyloxy)phenyl]-6-phenyl-4-pyridinyl]-Benzenamine, and 6′-(diethylamino)-2′-[(dimethylphenyl) amino]-3′-methylspiro[isobenzofuran-1(3H),9′-[9H]xanthene]-3-one, 4,4′-[(9-butyl-9H-carbazol-3-yl)methylene]bis[Nmethyl-N-phenylaniline] (CAS No. 67707-04-4), 6′-(diethylamino)-3-oxospiro[isobenzofuran-1(3H),9′-(9H)xanthene]-2′carboxylic acid ethyl ester (CAS No. 154306-60-2), and 2′-(dibenxylamino)-6′-(diethylamino)fluoran (CAS No. 34372-72-0), preferably wherein the leuco dye is selected from 2′-Anilino-6′-(dibutylamino)-3′-methyl-3H-spiro[2-benzofuran-1,9′-xanthen]-3-one , 6′-(Diethylamino)-3′-methyl-2′ -(phenylamino)spiro[2-benzofuran-3,9′-xanthene]-1-one, and 2-Anilino-6′-[ethyl(p-toyl)amino]-3′-methylspiro[5 isobenzofuran-1 (3H), 9′-[9H]xanthene]-3-one, preferably 2′-Anilino-6′-(dibutylamino)-3′-methyl-3H-spiro[2-benzofuran-1,9′-xanthen]-3-one, and 2-Anilino-6′-[ethyl(p-toyl)amino]-3′-methylspiro[5 isobenzofuran-1 (3H), 9′-[9H]xanthene]-3-one, and optionally wherein the thermal acid-generating agent is selected from 4-Hydroxyphenyl-4′-isopropoxyphenyl sulfone (Chameleon Developer-1); N-(p-toluenesulfonyl)-N′-(3-(p-toluenesulfonyloxy)phenyl)urea (Pergafast 201); 1,1,1-Tris(4-Hydroxyphenyl)Ethane (THPE) and thermal acid-generating agents based on amine salts of borobenzylate and tri-n-butylammonium borodisalicylate such as N,N-dibutylbutan-1-aminium bis [2-(hydroxy-kO)benzoato(2-)-kO]borate(1-), tri-n-butylammonium-4,4′-dioxo-4H,4′H-2,2′-spirobi[benzo[d][1,3,2]dioxaborinin]-2-uide, as well as 4-hydroxy-4′-isopropoxydiphenylsulfone, (2,4-dihydroxyphenyl)phenylmethanone, 3-(3-tosylureido)phenyl-4-methylbenzenesulfonate, propyl-3,4,5-trihydroxybenzoate and 4,4′-methanediyldiphenol, preferably N,N-dibutylbutan-1-aminium bis[2-(hydroxy-kO)benzoato(2-)-kO]borate(1-), 1,1,1-Tris(4-Hydroxyphenyl)Ethane (THPE), tri-n-butylammonium-4,4′-dioxo-4H,4′H-2,2′-spirobi[benzo[d][1,3,2]dioxaborinin]-2-uide, 4-hydroxy-4′-isopropoxydiphenylsulfone, (2,4-dihydroxyphenyl)phenylmethanone, 3-(3-tosylureido)phenyl-4-methylbenzenesulfonate, or propyl-3,4,5-trihydroxybenzoate and 4,4′-methanediyldiphenol, more preferably N,N-dibutylbutan-1-aminium bis[2-(hydroxy-kO)benzoato(2-)-KO]borate(1-) and 1,1,1-Tris(4-Hydroxyphenyl)Ethane (THPE), and more preferably 1,1,1-Tris(4-Hydroxyphenyl)Ethane (THPE).

42. The composition according to claim 2, wherein when the colour-forming compound is an oxyanion of a multivalent metal or oxyacid or hydrate thereof, the oxyanion of a multivalent metal or oxyacid or hydrate thereof is an oxyanion of a multivalent metal or hydrate of an oxyanion of a multivalent metal, preferably sodium molybdate dihydrate, or an ammonium salt of an oxyanion of a multivalent metal, preferably sodium molydbate dihydrate, or an ammonium salt of an oxyanion of molybdenum, preferably sodium molybdate dihydrate, or ammonium octamolybdate (AOM), and more preferably ammonium octamolybdate (AOM), preferably wherein the colour-forming compound is the oxyanion of a multivalent metal or oxyacid or hydrate thereof, preferably an oxyanion of a multivalent metal or hydrate of an oxyanion of a multivalent metal, preferably sodium molybdate dihydrate, or an ammonium salt of an oxyanion of a multivalent metal, preferably sodium molybdate dihydrate, or an ammonium salt of an oxyanion of molybdenum, preferably sodium molybdate dihydrate, or ammonium octamolybdate (AOM), and more preferably ammonium octamolybdate (AOM).

43. The composition according to claim 2, wherein the infrared radiation absorbing agent is selected from inorganic copper salts such as copper (II) hydroxyl phosphate (CHP); organic NIR dyes and pigments, such as N,N,N′,N′-tetrakis(4-dibutylaminophenyl)-p-benzoquinone bis(iminium hexafluoro-antimonate); non-stoichiometric, reduced or doped inorganic compounds such as reduced indium tin oxide, reduced zinc oxide, reduced tungsten oxide, reduced doped tungsten oxide including an inorganic compound of the following formula MxWyOz (where M is at least one element selected from the group consisting of H, He, alkali metal, alkaline earth metal, rare earth element, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi and I, W is tungsten, O is oxygen, satisfying 0.001≤x/y≤1; and 2.2≤z/y≤3.0.), reduced antimony tin oxide, or doped metal oxides such as aluminium-doped zinc oxide (AZO) and fluorine-doped tin oxide (FTO); conductive polymers such as poly polystyrene sulfonate (PEDOT); and combinations thereof, preferably the infrared radiation absorbing compound is selected from inorganic copper salts such as copper (II) hydroxyl phosphate (CHP), and non-stoichiometric, reduced or doped inorganic compounds such as reduced indium tin oxide, reduced zinc oxide, reduced tungsten oxide, reduced doped tungsten oxide including an inorganic compound of the following formula MxWyOz (where M is at least one element selected from the group consisting of H, He, alkali metal, alkaline earth metal, rare earth element, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi and I, W is tungsten, O is oxygen, satisfying 0.001≤x/y≤1; and 2.2≤z/y≤3.0.).

44. A substrate comprising a composition according to claim 2 applied thereon, preferably wherein the composition is on the exterior of the substrate or multi-layer substrate construction such that it is exposed, optionally wherein the substrate or multi-layer substrate construction is a packaging article, preferably a packaging product including paper-based and containers boxes including cardboard and cartonboard boxes, paper-based tubes including cardboard tubes, plastic bottles, paper-based bottles, plastic lids, glass bottles, aluminium cans and lids, steel cans and lids, wrap around labels, stretch sleeves, shrink sleeves, and self-adhesive labels, and optionally the hot melt adhesive of the composition is a bio-plastic thermoplastic polymer, copolymer, oligomer, or mixture thereof, and the substrate or multi-layer substrate construction is formed from a bio-plastic material.

45. A multi-layer substrate construction comprising a composition according to claim 2 applied thereon and/or incorporated therein, preferably wherein the composition is on the exterior of the substrate or multi-layer substrate construction such that it is exposed, optionally wherein the substrate or multi-layer substrate construction is a packaging article, preferably a packaging product including paper-based and containers boxes including cardboard and cartonboard boxes, paper-based tubes including cardboard tubes, plastic bottles, paper-based bottles, plastic lids, glass bottles, aluminium cans and lids, steel cans and lids, wrap around labels, stretch sleeves, shrink sleeves, and self-adhesive labels, and optionally wherein the hot melt adhesive of the composition is a bio-plastic thermoplastic polymer, copolymer, oligomer, or mixture thereof, and the substrate or multi-layer substrate construction is formed from a bio-plastic material.
